(19) United States
(12) Patent Application Publication
(10) Pub. No.: US 2023/0366729 A1
(43) Pub. Date: Nov. 16, 2023

(54) TRAINED AUTOENCODER, TRAINED AUTOENCODER GENERATION METHOD, NON-STATIONARY VIBRATION DETECTION METHOD, NON-STATIONARY VIBRATION DETECTION DEVICE, AND COMPUTER PROGRAM

(71) Applicant: SI SYNERGY TECHNOLOGY CO., LTD., Tokyo (JP)

(72) Inventors: Hideyuki SHIMURA, Tokyo (JP); Akira WADA, Tokyo (JP)

(21) Appl. No.: 18/246,094

(22) PCT Filed: Sep. 24, 2020
(86) PCT No.: PCT/JP2020/035989

§ 371 Date: Mar. 21, 2023

(51) Int. Cl. G01H 17/00; G06N 20/00

(52) U.S. Cl. CPC G01H 17/00; G06N 20/00

(57) ABSTRACT

Provided is a trained artificial intelligence for detecting non-stationarity of an object, which accurately functions even in the presence of an environmental sound. Stationary vibration feature data generated from stationary vibration data that is data about stationary vibration including vibration generated in a stationary state from an object for which detection of non-stationarity is performed based on sound, the stationary vibration feature data being data about a feature of stationary vibration identified by the stationary vibration data, is input to an autoencoder to cause the autoencoder to output estimated stationary vibration feature data. A loss function between the stationary vibration feature data and the estimated stationary vibration feature data is generated, and the autoencoder is trained to minimize a difference therebetween. By repeating the above-mentioned processing, the trained autoencoder is obtained from the autoencoder.

### CROSS-REFERENCE TO RELATED APPLICATION(S)

This application is a national stage application of International Patent Application No. PCT/JP2020/035989, filed Sep. 24, 2020 (WO 2022/064590 A1, published Mar. 31, 2022), which is herein incorporated by reference in its entirety.

### TECHNICAL FIELD

The present embodiments mainly relate to a technology of detecting non-stationarity of an object based on vibration including a sound generated from the object.

### BACKGROUND ART

The present embodiments are directed to detection of non-stationarity of an object based on vibration (sound), the details of which are described later. In contrast, most (and possibly all) related arts detect abnormality of an object or determine whether the object has normality or abnormality based on vibration (sound).

The difference between determination of the non-stationarity of an object (determination that the object is in the non-stationary state) and determination of abnormality of the object (or whether the object has normality or abnormality) is described later. Prior to that description, the related arts are described in order. The description of the related arts is provided focusing on sound, which is vibration of air (the “sound” in the present application also includes a sound having a frequency other than the audible range), as an example of vibration.

For example, it is assumed that the object is a machine. The idea itself of detecting a failure of the machine by sound (vibration) or detecting a failure of a structure, equipment, or the like by sound (vibration) has existed for a long time as a non-destructive inspection method, and can be said to be classical.

It is well known that a machine that is out of order or is about to break down produces an abnormal sound, and it is very common to detect a failure or an impending failure of the machine based on the abnormal sound. It is also well known that when an undesirable situation arises in a structure or the like, for example, when a wall or the like is cracked, an abnormal sound is mixed with a sound generated in a hammering test, and it is common knowledge that occurrence of the abnormal sound indicates that a failure has occurred or is about to occur in the structure or the like.

Conventionally, such an abnormal sound has been detected by a skilled person.

Incidentally, an artificial intelligence has been remarkably developed in recent years, and there has naturally occurred a movement to replace a person skilled in recognizing the machine failure or the abnormal sound mixed during the hammering test by sound with the artificial intelligence.

A case in which the object is a machine is described as an example. A large amount of data of a normal sound that is a sound of the machine in the normal state is sampled, and a large amount of data of an abnormal sound that is a sound of the machine that has broken down or will break down in the near future is sampled. The artificial intelligence is then caused to learn both the normal sound data and the abnormal sound data with labels indicating that the sound identified by the normal sound data and the sound identified by the abnormal sound data are the normal sound and the abnormal sound, respectively. Then, when data of a sound generated by the object (that is, the machine as a target of detection or determination as to whether a current state is normal or abnormal) is input to the trained artificial intelligence, the artificial intelligence determines whether the sound identified by the input sound data is the normal sound or the abnormal sound.

As a matter of course, when the sound has been determined to be the abnormal sound, determination can be made that the machine is out of order or will break down in the near future. This determination can be divided into more than two levels, depending on the types of labels.

### CITATION LIST

### Patent Literature

[PTL 1] JP 2020-126021 A

### SUMMARY

### Technical Problem

It can be said that the abnormal sound detection technology using the artificial intelligence as described above is obtained by simply replacing the ability of the skilled person with the artificial intelligence. The above-mentioned artificial intelligence determines whether the sound identified by input sound data is the normal sound or the abnormal sound based on whether the input sound data is closer to the learned normal sound data or the learned abnormal sound data.

Incidentally, the human brain has an ability to focus on only a sound that he or she wants to hear and to recognize only the sound even in a situation in which various types of noise are generated. Therefore, for example, even when the machine is located in a factory and there are footsteps or noise generated by workers around the machine, or even when the sound of a car running outside the factory reaches the inside of the factory, or in some cases, even when the sound of a police car running while sounding a siren reaches the inside of the factory, a skilled person can hear only the sound of the target machine and can accurately determine the state of the machine.

However, the artificial intelligence does not have such a convenient ability. Therefore, it is required that the sound input to the artificial intelligence not include such an environmental sound (noise) with regard to the normal sound and the abnormal sound used in the training stage and with regard to a sound newly input in order to determine the state of the machine. It is not realistic to obtain a sound that includes only the sound from the machine without the environmental sound.

Therefore, in order to generate the trained artificial intelligence as described above or to operate the artificial intelligence, it is required to perform noise canceling processing for sound data so as to remove the environmental sound from a sampled sound and extract only the sound generated from the machine as the target of state determination. As a matter of course, it takes time and cost to achieve the noise canceling processing. Further, there are various types of environmental sounds to be subjected to noise canceling, and hence the noise canceling is required to be ideally adapted to all the types of environmental sounds. In order to perform such ideal processing, it is required to identify what kind of environmental sound is to be subjected to the noise canceling processing and to establish a noise canceling technology for each environmental sound, and thus the effort and cost are enormous. In addition, when an unexpected environmental sound is generated, noise canceling may not be effective in the first place.

Further, training of the above-mentioned artificial intelligence requires a very large amount of data of normal sound and abnormal sound as described above. This means that a lot of effort and cost are required for generating the trained artificial intelligence.

When the target of determination is a machine, it is required to sample a large amount of data of normal sound that is a sound generated by the machine in the normal state after confirmation that the machine operates normally, and to sample a large amount of data of abnormal sound after confirmation that the machine is in the abnormal state. The number of pieces of data to be sampled increases more and more when sound sampling is conducted not only for two levels including a normal level and an abnormal level but also for multiple levels obtained by, for example, dividing the abnormal level from mild to severe.

In addition, the sampled sound data is required to be correctly labeled in order to enable the artificial intelligence to be trained. This also increases the effort and cost.

However, in order to obtain the trained artificial intelligence described above, such effort and cost are inevitable.

The present embodiments may provide a trained artificial intelligence for detecting non-stationarity of an object, which accurately functions even in the presence of an environmental sound, and may provide a technology for reducing the effort and cost required for obtaining such a trained artificial intelligence as compared with the related arts.

Further, the present embodiments may also provide a technology for accurately detecting non-stationarity of an object even in the presence of an environmental sound through use of such a trained artificial intelligence.

### Solution to Problem

The concept of the present embodiments is roughly described prior to the specific description of the present embodiments.

First, the definition of the term “non-stationarity” in the present application is described. The “non-stationarity (or non-stationary state)” in the present application means a state in which vibration (sound) other than vibration (sound) generated from an object during pre-training performed in a manner described later is generated from the object. That is, in the present embodiments, an autoencoder described later is caused to learn vibration (sound) generated in a stationary state. From the viewpoint of an anthropomorphic autoencoder, a state in which only vibration (sound) that the autoencoder has learned is generated is the stationary state, and a state in which vibration (sound) that the autoencoder has not learned is generated is a non-stationary state.

Again, sound is taken as an example of vibration.

For example, it is assumed that the object is a machine, and a sound including a sound generated by the machine when the machine is operating normally (a sound also including an ambient sound, that is, an environmental sound that is to be referred to as noise) is a sound generated in a stationary state. In the case in which the machine has a failure or another malfunction (or is in a state in which a malfunction will occur in the near future), when the machine generates an abnormal sound, the state in which a sound including the abnormal sound is generated is a non-stationary state. That is, in this example, when the non-stationarity of the object can be detected, it is possible to detect that a malfunction has occurred in the machine or that a malfunction will occur in the near future.

In addition, it is assumed that the object is a certain structure, for example, a bridge. It is also assumed that a sound including a sound given by the bridge struck by a hammer to perform a hammering test when there is no problem in the bridge (sound further including an environmental sound) is a sound generated in a stationary state. In the case in which a malfunction such as a crack has occurred in the bridge (or the bridge is in a state in which such a malfunction will occur in the near future), when the struck bridge generates an abnormal sound, the state in which a sound including the abnormal sound is generated is a non-stationary state. That is, in this example, when the non-stationarity of the object can be detected, it is possible to detect that a malfunction has occurred in the bridge or a malfunction will occur in the near future.

Further, it is assumed that the object is a meeting room during a meeting. It is also assumed that a voice of a meeting participant and a sound of pulling a chair are sounds generated in the stationary state when the meeting is held in a normal state. For example, when an abnormal sound is generated as a result of, for example, the participant making a strange voice or a sound of breaking something when a fight between participants occurs during the meeting, although such a situation is rare, the state in which a sound including the abnormal sound is generated is a non-stationary state. That is, in this example, when the non-stationarity of the object can be detected, it is possible to detect that the meeting is not being held normally. When the object is a street corner, it may be possible to detect that a major incident or accident has occurred at the street corner.

That is, when the artificial intelligence is caused to learn data of stationary sound, which is a sound generated from the object in the stationary state, as data of sound including the environmental sound as it is by machine learning, data of measurement sound which is a sound required for determining the state of the object may also be data of sound including the environmental sound as it is. That is, it is not required to perform noise canceling also when sound data required for pre-training of the artificial intelligence is prepared and when measurement sound data is generated, and hence there is thus a possibility that the artificial intelligence can perform accurate determination even when the measurement sound data including the environmental sound is used as it is.

In addition, when it is not required to perform noise canceling when the data of stationary sound is obtained and when the data of measurement sound is obtained, the effort and cost for noise canceling can be saved. Moreover, when the data required for obtaining the trained artificial intelligence is only the data of stationary sound, the effort and cost required for collecting and labeling the data can be reduced remarkably as compared with the related-art method of separately collecting the data of stationary sound and the data of abnormal sound and labeling those pieces of data.

In addition, the trained artificial intelligence generated based on the data of stationary sound as described above may be able to detect or determine non-stationarity in the meeting room or the street corner described above which is other than the objects of related-art abnormality detection by sound, such as the machine, the structure, and the equipment.

However, in order for the trained artificial intelligence that has been trained with only stationary sound data to correctly detect the non-stationary state that is not the stationary state, a method or an algorithm different from that used in the related-art artificial intelligence is required.

The present embodiments relate to such a method or algorithm that has been generated as a result of research and development performed by the inventors of the present application in order to achieve the above-mentioned concept.

The inventors of the present application propose the following trained autoencoder as an aspect of the present embodiments. This trained autoencoder is the core of an artificial intelligence in the present embodiments.

The trained autoencoder in the present embodiments is formed by an autoencoder that encodes input data being predetermined data and then decodes the encoded data to obtain data having the same dimensions as those of the input data. Such an autoencoder is publicly known or well known in the field of artificial intelligence, and is widely used for unsupervised learning of artificial intelligence, although the autoencoder is also used to some extent for supervised learning of artificial intelligence.

The trained autoencoder in the present embodiments is generated based on such an autoencoder. Input data is stationary vibration feature data generated from stationary vibration data that is data having a specific duration about stationary vibration including vibration generated in a stationary state from an object for which detection of non-stationarity is performed based on vibration, the stationary vibration feature data being data about a feature of stationary vibration identified by the stationary vibration data, and output data is estimated stationary vibration feature data. Further, the trained autoencoder is obtained by performing pre-training by inputting a plurality of pieces of the stationary vibration feature data so that a difference between the stationary vibration feature data being input data and the estimated stationary vibration feature data being output data with respect to the input data is minimized.

Information input to the autoencoder during training in the case in which this trained autoencoder is generated is not the stationary vibration data that is data having the specific duration about the stationary vibration including the vibration generated in the stationary state from the object for which detection of non-stationarity based on vibration is performed, but the stationary vibration feature data generated from the stationary vibration data and being data about the feature of the stationary vibration identified by the stationary vibration data. Simply put, the autoencoder receives data about a feature of vibration generated by the object in the stationary state and a feature of vibration also including ambient vibration that can also be referred to as environmental vibration as inputs. The stationary vibration feature data is, for example, a frequency spectrogram generated from the stationary vibration data. One example of vibration is sound, which is vibration of air. Accordingly, the stationary vibration may be a sound generated in the stationary state. In this case, the stationary vibration feature data may be a mel-frequency spectrogram generated from the stationary vibration data.

The output of this autoencoder is estimated stationary vibration feature data. This autoencoder repeats input and output over and over, thereby being trained in such a manner that the stationary vibration feature data as the input and the estimated stationary vibration feature data as the output are as close to being identical as possible. The trained autoencoder of the present embodiments is trained in such a manner that, when certain data is encoded and then decoded, input data and output data are as close to being identical as possible. The target of learning is data of a feature of stationary vibration generated from stationary vibration data. That is, the trained autoencoder according to the present embodiments can be said to be tuned such that the input data and the output data are close to being identical when the input data is stationary vibration feature data, and can be roughly said to be the trained autoencoder with which the input data and the output data can approximately be the same when the input data is data related to vibration (sound) generated in the stationary state. Further, it can be said that the trained autoencoder of the present application is an autoencoder that has been tuned exclusively for vibration (sound) generated in the stationary state for causing the input and the output to be substantially the same as each other.

When such a trained autoencoder is used, as described later, it becomes possible to determine whether the state of the object is in the stationary state or the non-stationary state based on vibration or sound, and it becomes possible to detect the non-stationary state.

Although a method of using the trained autoencoder is described later, the effort and cost for generating the trained autoencoder are reduced at least as compared with the case of machine learning required in the related arts. This is because data required for generating the trained autoencoder is only data in the stationary state, data in the non-stationary state (for example, a state in which an abnormality occurs) is not required, and only one type of data is input, and hence labeling is also not required. Moreover, in general, the time during which the object is in the stationary state is longer than the time during which the object is in the non-stationary state, and therefore data of vibration or sound when the object is in the stationary state can be easily collected.

In the autoencoder during training, any method may be adopted as a method for minimizing a difference between the stationary vibration feature data and the estimated stationary vibration feature data that is the output data with respect to the input data. Among publicly-known or well-known methods of training the autoencoder, there is a method for minimizing the difference between the input and the output. For example, in order to minimize the difference between the stationary vibration feature data and the estimated stationary vibration feature data that is the output data with respect to the input data, the following techniques can be used. A loss function is generated for the difference between the stationary vibration feature data and the estimated stationary vibration feature data that is the output data with respect to the input data, and the generated loss function is minimized. With this configuration, by appropriately performing at least one of selection or design of the loss function, it is possible to obtain an advantageous effect that a desired difference can be extracted in accordance with the characteristic to be extracted as the difference between the stationary vibration feature data and the estimated stationary vibration feature data that is the output data when the input data is input to the autoencoder (for example, the characteristic in the case in which a case in which there is a sudden difference change is to be extracted, or in the case in which a difference between overall feature data tendencies is to be extracted). A plurality of types of loss functions are publicly-known or well-known, and an applicable one can be appropriately selected and used from among such loss functions. In actual use, it is also possible to further adjust the selected loss function by a publicly-known or well-known technology.

The inventors of the present application also propose a method of generating the above-mentioned trained autoencoder as an aspect of the present embodiments. The advantageous effects of this method are the same as those of the above-mentioned trained autoencoder.

The method being an example is a method of generating a trained autoencoder from an autoencoder that encodes input data being predetermined data and then decodes the encoded predetermined data to obtain data having the same dimensions as dimensions of the input data, the input data being stationary vibration feature data generated from stationary vibration data that is data having a specific duration about stationary vibration that is vibration generated in a stationary state from an object for which detection of non-stationarity is performed based on vibration, the stationary vibration feature data being data about a feature of stationary vibration identified by the stationary vibration data, output data being estimated stationary vibration feature data, the method including performing pre-training of the autoencoder by inputting a plurality of pieces of the stationary vibration feature data so that a difference between the stationary vibration feature data being the input data and the estimated stationary vibration feature data being the output data with respect to the input data is minimized.

This method may further include generating, in order to minimize the difference between the stationary vibration feature data and the estimated stationary vibration feature data being the output data with respect to the input data, a loss function for the difference between the stationary vibration feature data and the estimated stationary vibration feature data being the output data with respect to the input data so that the generated loss function is minimized.

The inventors of the present application also propose a non-stationary vibration detection device which uses the above-mentioned trained autoencoder as an aspect of the present embodiments.

The non-stationary vibration detection device as an example (hereinafter may simply be referred to as “detection device” in some cases) is a non-stationary vibration detection device including: a first recording unit having the above-mentioned trained autoencoder of the present embodiments recorded therein; a receiving unit configured to receive measured vibration data that is data having a specific duration about measured vibration including vibration generated from the object for which detection of non-stationarity based on vibration is performed; a measured vibration feature data generation unit configured to generate, from the measured vibration data received by the receiving unit, measured vibration feature data that is data about a feature of measured vibration identified by the measured vibration data, by the same method as a method of generating the stationary vibration feature data from the stationary vibration data in pre-training; a first arithmetic unit configured to read the trained autoencoder recorded in the first recording unit and to input the measured vibration feature data generated by the measured vibration feature data generation unit to the trained autoencoder to obtain estimated measured vibration feature data that is an output from the trained autoencoder in response to the input measured vibration feature data; and a second arithmetic unit configured to obtain a difference between the measured vibration feature data generated by the measured vibration feature data generation unit and the estimated measured vibration feature data generated from the measured vibration feature data by the first arithmetic unit and to determine, when the difference is larger than a predetermined range, that measured vibration identified by measured vibration data from which the measured vibration feature data is derived is non-stationary vibration and generate result data indicating occurrence of non-stationary vibration.

This non-stationary vibration detection device includes the first recording unit having the above-mentioned trained autoencoder recorded therein. The trained autoencoder recorded in the first recording unit is used in a manner described later.

This detection device includes the receiving unit that receives data from which data to be input to the trained autoencoder is derived. The data received by the receiving unit is measured vibration data, which is data having a specific duration about measured vibration including vibration generated from the object for which detection of non-stationarity based on vibration is performed. That is, this detection device detects non-stationary vibration based on measured vibration including vibration generated from the object.

This detection device includes the measured vibration feature data generation unit. The measured vibration feature data generation unit generates, from the measured vibration data received by the receiving unit, measured vibration feature data that is data about a feature of measured vibration identified by the measured vibration data thus received. The measured vibration data has the same data format and type as those of the stationary vibration data used in a pre-training stage. The measured vibration feature data is generated by the same method as the method used when stationary vibration feature data is generated from the stationary vibration data in the pre-training stage. The measured vibration feature data is input to the trained autoencoder. The measured vibration feature data and the stationary vibration feature data input to the autoencoder during training for training of the trained autoencoder are both data about vibration, and hence the data formats or types of both are the same.

The measured vibration feature data may be a frequency spectrogram generated from the measured vibration data. As described above, the stationary vibration feature data may be the frequency spectrogram obtained from the stationary vibration data. In this case, the measured vibration feature data is a frequency spectrogram generated from the measured vibration data. The measured vibration feature data may be data about a sound including a sound generated during detection of non-stationarity based on vibration, that is, a sound generated from the object during such detection. In this case, the measured vibration feature data may be a mel-frequency spectrogram generated from the measured vibration data. As described above, in the case in which the stationary vibration data is sound data, the stationary vibration feature data may be a mel-frequency spectrogram generated from the stationary vibration data. In this case, the measured vibration feature data is a mel-frequency spectrogram generated from the measured vibration data that is sound data.

This non-stationary vibration detection device includes the first arithmetic unit. The first arithmetic unit reads the trained autoencoder recorded in the first recording unit, and causes the trained autoencoder to function. The first arithmetic unit inputs the measured vibration feature data generated by the measured vibration feature data generation unit to the trained autoencoder read from the first arithmetic unit, and obtains estimated measured vibration feature data as the output of the trained autoencoder.

The trained autoencoder has been tuned so as to, when data about a feature of stationary vibration (stationary vibration feature data while training is performed) is input thereto, output the estimated stationary vibration feature data that is approximately the same as the input data, as described above. Therefore, in the case in which the measured vibration identified by the measured vibration data from which the measured vibration feature data is derived is stationary vibration (vibration including vibration from the object in the stationary state), the estimated stationary vibration feature data output from the trained autoencoder is approximately the same as the stationary vibration feature data from which the estimated stationary vibration feature data is derived. This conclusion does not change even when environmental vibration (an environmental sound in the case of sound) is included in the measured vibration identified by the measured vibration data from which the measured vibration feature data is derived. This is because, similarly to the case in which environmental vibration may be included in measured vibration, the environmental vibration may also be included in the stationary vibration identified by the stationary vibration data from which the stationary vibration feature data input to the trained autoencoder in the training process is derived, and therefore the component derived from the environmental vibration included in the measured vibration feature data can be regarded as the component derived from the stationary vibration that has already been learned from the point of view of the trained autoencoder, and is thus not recognized as a component deviated from the stationary vibration.

Meanwhile, the trained autoencoder used in the first arithmetic unit has been tuned such that the input and the output substantially match each other only when the input is data related to stationary vibration. In other words, the above-mentioned trained autoencoder can be said to be an autoencoder exclusively for the stationary state or stationary vibration, which can exhibit the function in which the input and output thereof substantially match each other only when the object is in the stationary state or when stationary vibration including vibration from the object in the stationary state is input and which has been trained specifically for the stationary state or stationary vibration. Therefore, when the measured vibration identified by the measured vibration data from which the measured vibration feature data is derived is non-stationary vibration including vibration from the object in non-stationary state, the trained autoencoder does not function in the same manner as when the object is in the stationary state (in other words, the trained autoencoder does not function as planned, or roughly, the trained autoencoder malfunctions). Therefore, the estimated stationary vibration feature data output from the trained autoencoder in this case is significantly different from the stationary vibration feature data from which the estimated stationary vibration feature data is derived. For the reason described above, this conclusion is also the same even when environmental vibration is included in measured vibration.

This detection device includes the second arithmetic unit. The second arithmetic unit functions as an artificial intelligence that detects that the object is in the non-stationary state based on the measured vibration data received from the outside by cooperating with the first arithmetic unit or by cooperating with the measured vibration feature data generation unit and the first arithmetic unit.

The second arithmetic unit obtains a difference between the measured vibration feature data generated by the measured vibration feature data generation unit and the estimated measured vibration feature data generated from the measured vibration feature data by the first arithmetic unit and, when the difference is larger than a predetermined range, determines that the measured vibration identified by the measured vibration data from which the measured vibration feature data is derived is non-stationary vibration and generates result data indicating occurrence of non-stationary vibration. Simply put, the second arithmetic unit has a function of obtaining a difference between the input and the output of the trained autoencoder in the first arithmetic unit and determining, in accordance with the difference, whether measured vibration data from which the measured vibration feature data as the input is derived is non-stationary vibration including vibration from the object in non-stationary state or whether the object is in non-stationary state. It is assumed that the method executed to obtain the difference in the detection device is the same as the method executed to obtain the difference between the stationary vibration feature data and the estimated stationary vibration feature data in the pre-training of the trained autoencoder. As described above, when the measured vibration data is related to stationary vibration, the measured vibration feature data as the input to the trained autoencoder and the estimated measured vibration feature data as the output from the trained autoencoder substantially match each other. When the measured vibration data is related to non-stationary vibration, the measured vibration feature data as the input to the trained autoencoder and the estimated measured vibration feature data as the output from the trained autoencoder are significantly different from each other.

Through use of this property, the second arithmetic unit can determine whether the object generating vibration included in the measured vibration identified by the measured vibration data received by the detection device is in the stationary state or the non-stationary state by extracting the difference between the pieces of data, and further can generate result data indicating that the object is in the non-stationary state. After generating the result data, the second arithmetic unit may use the result data, for example, by recording the result data to a recording medium in the detection device or may output the result data to the outside of the detection device.

The result data that indicates that the object is in the non-stationary state may be used in any manner. For example, once the result data has been generated, the detection device or another predetermined device that has received the result data from the detection device may take an appropriate action to inform a user of the detection device of the fact that the object is in the non-stationary state. For example, the detection device or the other device may notify a predetermined user of the occurrence of the fact by an email or another message, or may notify the user of the occurrence of the fact by a method that allows the user to detect the notification by any of the five senses, for example, by displaying the fact on a display connected to the detection device or the other device or sounding a patrol lamp.

Further, by recording a large number of pieces of result data in a recording medium inside or outside the detection device in time series, for example, together with time stamps, it becomes possible to predict how the state of the object will change in the future from the tendency of the accumulated pieces of result data and verify the past history of the state of the object.

As is apparent from the above description, the non-stationary vibration detection device according to the present application can detect that the object is in the non-stationary state even when measured vibration data includes environmental vibration. This detection device is not required to apply a noise canceling technology to the measured vibration data.

This is achieved by a combination of the above-mentioned trained autoencoder generated by being caused to learn even the environmental vibration and an artificial intelligence including the first arithmetic unit and the second arithmetic unit (and the measured vibration feature data generation unit) that function by a mechanism completely different from the related-art mechanism. Although a related-art artificial intelligence functions based on comparison between learned stationary vibration (stationary sound) and measured vibration (measured sound), which is the same mechanism as the method performed by a skilled person, the artificial intelligence in the present embodiments employs a mechanism in which data input to the trained autoencoder that has learned in advance even environmental vibration (environmental sound) and data output from the trained autoencoder are compared with each other, and in rough terms, when the object is in the non-stationary state, the trained autoencoder is erroneously operated to detect that the object is in the non-stationary state. By employing this new mechanism, the non-stationary vibration detection device of the present embodiments can correctly detect that the object is in the non-stationary state even when the measured vibration data that is data about vibration including environmental vibration is input.

In addition, by employing the above-mentioned new mechanism, the detection device of the present application can also detect, as the non-stationary state, occurrence of an irregular situation in the object in a noisy environment as such, for example, in a meeting room or a street corner, in addition to related-art applications such as detection of an abnormality in the machine when the object is the machine and detection of occurrence of a crack in a bridge when the object is the bridge.

For example, this detection device detects vibration different from regular vibration (vibration that has already been learned by the trained autoencoder) or a sound different from a regular sound (sound that has already been learned by the trained autoencoder). Therefore, this detection device can freely select an object which emits the regular vibration or the regular sound as an object of detection, in other words, this detection device does not select the object of detection, and hence it is possible to detect non-stationarity by vibration or sound even for an object which has not been selected as the object of detection in the related art.

The second arithmetic unit of the detection device of the present embodiments obtains the difference between the measured vibration feature data generated by the measured vibration feature data generation unit and the estimated measured vibration feature data generated from the measured vibration feature data by the first arithmetic unit, as described above. At this time, how to detect the difference can be determined as appropriate.

For example, in order to obtain the difference between the measured vibration feature data generated by the measured vibration feature data generation unit and the estimated measured vibration feature data generated from the measured vibration feature data by the first arithmetic unit, the second arithmetic unit may generate a loss function for both, and determine that measured vibration identified by measured vibration data from which the measured vibration feature data is derived is non-stationary vibration when the number of values of the loss function which exceed a predetermined threshold value is a predetermined number or more.

With this configuration, the second arithmetic unit can detect whether vibration from the object includes non-stationary vibration, that is, whether the object is in the non-stationary state, only by counting the number of values of the loss function exceeding the threshold value.

In addition, the use of the above-mentioned threshold value has the following advantages. In the case of related-art artificial intelligence, the type of a value output from the artificial intelligence basically depends on the type of data learned in advance by the artificial intelligence. For example, when levels of an abnormal sound generated from the object output by the artificial intelligence are four levels: normal, average, bad, and worst, the types of data to be learned in advance by the artificial intelligence are required to be data in accordance with the above-mentioned four levels with labels corresponding to the four levels of data. However, in the case in which the second arithmetic unit uses the threshold value as described above, even when the data learned by the trained autoencoder of the present embodiments is only data in stationary state, it is possible to obtain different determination results from the same loss function only by changing the threshold value. This means that the four levels can be determined in the above-mentioned example without complicating pre-training in the trained autoencoder. In order to obtain this advantageous effect, needless to say, the threshold value used in the second arithmetic unit can be changed in the detection device of the present embodiments. The change of the threshold value can be performed by, for example, input from a predetermined input device (keyboard, mouse, or the like) connected to the detection device. In addition, the change of the threshold value can be automatically performed by the detection device itself in accordance with a predetermined rule.

The inventors of the present application also propose a non-stationary vibration detection method to which the trained autoencoder of the present embodiments is applied, as an aspect of the present embodiments. The advantageous effects of this method are the same as those of the non-stationary vibration detection device according to the present embodiments.

The method as one example is a non-stationary vibration detection method, which is executed by a computer including a first recording unit having the trained autoencoder described above recorded therein, the method including the following steps which are all executed by the computer.

The steps include: a first step of receiving measured vibration data that is data having a specific duration about measured vibration including vibration generated from the object for which detection of non-stationarity based on vibration is performed; a second step of generating, from the measured vibration data received in the first step, measured vibration feature data that is data about a feature of measured vibration identified by the measured vibration data, by the same method as a method of generating the stationary vibration feature data from the stationary vibration data in pre-training; a third step of reading the trained autoencoder recorded in the first recording unit and inputting the measured vibration feature data generated in the second step to the trained autoencoder to obtain estimated measured vibration feature data that is an output from the trained autoencoder in response to the measured vibration feature data; and a fourth step of obtaining a difference between the measured vibration feature data generated in the second step and the estimated measured vibration feature data generated from the measured vibration feature data in the third step and determining, when the difference is larger than a predetermined range, that measured vibration identified by measured vibration data from which the measured vibration feature data is derived is non-stationary vibration and generating result data indicating occurrence of non-stationary vibration.

The inventors of the present application also propose a computer program for causing a predetermined computer to function as the non-stationary vibration detection device to which the trained autoencoder of the present embodiments is applied, as an aspect of the present embodiments. The advantageous effects of this computer program are the same as those of the non-stationary vibration detection device according to the present embodiments, and also include an effect of being able to cause a general purpose computer to function as the non-stationary vibration detection device according to the present embodiments.

The computer program as one example is a computer program for causing a predetermined computer to function as a non-stationary vibration detection device.

This computer program is a computer program for causing the predetermined computer to function as: a first recording unit having a trained autoencoder recorded therein, the trained autoencoder being obtained by performing pre-training of an autoencoder that encodes input data being predetermined data and then decodes the encoded predetermined data to obtain data having the same dimensions as dimensions of the input data, the input data being stationary sound vibration feature data generated from stationary sound vibration data that is data having a specific duration about stationary sound vibration including sound vibration generated in a stationary state from an object for which detection of non-stationarity is performed based on sound vibration, the stationary vibration feature data being data about a feature of stationary sound vibration identified by the stationary sound vibration data, output data being estimated stationary sound vibration feature data, the pre-training being performed by inputting a plurality of pieces of the stationary sound vibration feature data so that a difference between the stationary sound vibration feature data being the input data and the estimated stationary sound vibration feature data being the output data with respect to the input data is minimized; a receiving unit configured to receive measured vibration data that is data having a specific duration about measured vibration including vibration generated from the object for which detection of non-stationarity based on vibration is performed; a measured vibration feature data generation unit configured to generate, from the measured vibration data received by the receiving unit, measured vibration feature data that is data about a feature of measured vibration identified by the measured vibration data, by the same method as a method of generating the stationary vibration feature data from the stationary vibration data in the pre-training; a first arithmetic unit configured to read the trained autoencoder recorded in the first recording unit and to input the measured vibration feature data generated by the measured vibration feature data generation unit to the trained autoencoder to obtain estimated measured vibration feature data that is an output of the trained autoencoder in response to the input measured vibration feature data; and a second arithmetic unit configured to obtain a difference between the measured vibration feature data generated by the measured vibration feature data generation unit and the estimated measured vibration feature data generated from the measured vibration feature data by the first arithmetic unit, and to determine, when the difference is larger than a predetermined range, that measured vibration identified by measured vibration data from which the measured vibration feature data is derived is non-stationary vibration and generate result data indicating occurrence of non-stationary vibration.

As described above, the second arithmetic unit may determine, through use of the loss function and the threshold value, whether measured vibration identified by measured vibration data from which measured vibration feature data is derived includes non-stationary vibration. In this case, how to determine the threshold value becomes a problem. As a matter of course, this threshold value can be determined manually.

Alternatively, the threshold value can be detected by the following method.

The method as one example is a method of determining the threshold value to be used in the non-stationary vibration detection device according to the present embodiments including the second arithmetic unit which determines, through use of the loss function and the threshold value, whether measured vibration identified by measured vibration data from which measured vibration feature data is derived includes non-stationary vibration. This method includes: a step A of inputting, to the trained autoencoder, the stationary vibration feature data generated from the stationary vibration data not used for training of the trained autoencoder and being data about a feature of stationary vibration identified by the stationary vibration data, to obtain the estimated stationary vibration feature data as an output of the trained autoencoder; a step B of generating a loss function for a difference between the stationary vibration feature data input to the trained autoencoder in the step A and the estimated stationary vibration feature data generated by the trained autoencoder from the stationary vibration feature data; and a step C of determining the threshold value based on a mean and a variance of an amplitude related to an error of the loss function obtained in the step B.

In the step A, stationary vibration feature data generated from stationary vibration data not used for training of the trained autoencoder and being data about a feature of stationary vibration identified by this stationary vibration data is input to the trained autoencoder. The trained autoencoder then outputs estimated stationary vibration feature data, as already described.

In the step B, a loss function for a difference between the stationary vibration feature data input to the trained autoencoder and the estimated stationary vibration feature data generated from the stationary vibration feature data is generated.

In the step C, a threshold value is determined based on a mean and a variance of an amplitude related to an error of the loss function obtained in the step B.

The loss function can be a function having a duration corresponding to the duration of the stationary vibration feature data (this is equal to the duration of the stationary vibration data), with the horizontal axis representing time and the vertical axis representing the magnitude of the error. When a graph of the loss function is plotted in such a manner that the mean of the magnitude of the errors in the loss function is set to the center of the vertical axis and the horizontal axis represents time, it is possible to determine a threshold value for determining whether an error is truly counted as an error (to what extent an error can be regarded as not being an error) based on what percentage of the number of errors exceeding the threshold value is allowed, automatically and objectively to some extent by using the amplitude and variance of the graph. The reason why the stationary vibration feature data that has not been used for pre-training of the trained autoencoder is used is to increase the objectivity of the threshold value by newly determining the threshold value for stationary vibration that has not been used for the pre-training. Note that, obtaining the threshold value through use of the standard deviation, which is the square root of the variance, and the mean of the loss function is equivalent to obtaining the threshold value through use of the variance and the mean of the loss function.

### BRIEF DESCRIPTION OF DRAWINGS

FIG. 1 is a schematic perspective view of an overall configuration of a training device in a first embodiment of the present embodiments;

FIG. 2 is a diagram for illustrating a hardware configuration of a computer device included in the training device illustrated in FIG. 1;

FIG. 3 is a block diagram for illustrating functional blocks generated in the computer device illustrated in FIG. 2;

FIG. 4 is a diagram for conceptually illustrating a configuration of an autoencoder included in the computer device illustrated in FIG. 2;

FIG. 5 is a graph for conceptually showing an example of a loss function generated by a loss function generation unit illustrated in FIG. 3;

FIG. 6 is a block diagram for illustrating functional blocks generated in a computer device included in a detection device according to the first embodiment;

FIG. 7 is a graph for conceptually showing an example of a loss function generated by a loss function generation unit illustrated in FIG. 6 when an object is in a stationary state;

FIG. 8 is a graph for conceptually showing an example of a loss function generated by the loss function generation unit illustrated in FIG. 6 when the object is in a non-stationary state;

FIG. 9 is a graph for conceptually showing an example of a loss function generated when a threshold value is determined in Test Example 1;

FIG. 10 is a graph for conceptually showing an example of a loss function generated when a sound data file of a sound including a cutting sound of level 2 has been input to a computer device of a detection device in Test Example 1;

FIG. 11 is a graph for conceptually showing an example of a loss function generated when a sound data file of a sound including a cutting sound of level 3 has been input to the computer device of the detection device in Test Example 1;

FIG. 12 is a graph for conceptually showing an example of a loss function generated when a sound data file of a sound including a cutting sound of level 4 has been input to the computer device of the detection device in Test Example 1;

FIG. 13 is a graph for conceptually showing an example of a loss function generated when a sound data file of a sound including a cutting sound of level 5 has been input to the computer device of the detection device in Test Example 1;

FIG. 14 is a graph for conceptually showing an example of a loss function generated when a file of stationary sound data has been input to a computer device of a training device in Test Example 2;

FIG. 15 is a graph for conceptually showing an example of a loss function generated when a file of sound data of Sample 1 has been input to a computer device of a detection device in Test Example 2; and

FIG. 16 is a graph for conceptually showing an example of a loss function generated when a file of sound data of Sample 2 has been input to the computer device of the detection device in Test Example 2.

### DESCRIPTION OF EMBODIMENTS

First and second preferred embodiments of the present embodiments are described below with reference to the drawings. In addition, test examples performed through use of a detection device according to the first embodiment are also described later.

In the description of both the embodiments, the same object is labeled with the same reference symbols, and redundant description may be omitted. In addition, the technical contents described in the respective embodiments can be combined with each other as long as there is no particular contradiction.

### First Embodiment

A non-stationary vibration detection device (hereinafter may simply be referred to as “detection device”) is described in the first embodiment.

The non-stationary vibration detection device includes a trained autoencoder as described later. Therefore, to obtain the non-stationary vibration detection device, it is required to obtain the trained autoencoder first. In this embodiment, a device required for obtaining the trained autoencoder is referred to as “training device” for the sake of convenience.

The non-stationary vibration detection device in this embodiment uses a threshold value described later when detecting non-stationary vibration, although it is not necessarily required to use the threshold value. In this embodiment, the threshold value is generated by the above-mentioned training device used for obtaining the trained autoencoder. The threshold value may be generated by the detection device, not by the training device, or may be generated by a device other than the training device and the detection device.

As described above, to achieve the non-stationary vibration detection device, the training device and, in some cases, another device for determining the threshold value which is different from the detection device and the training device are required in addition to the detection device. However, the required devices that are three at the maximum, namely, the detection device, the training device, and the other device can be the same as one another in required hardware configuration, and hence those devices can be integrated into one device by appropriately preparing computer programs to be installed in those devices. Therefore, needless to say, any two of the required devices that are three at the maximum, namely, the detection device, the training device, and the other device described above can be integrated into one device.

In this embodiment, the threshold value is determined by the training device as already described. This means that this embodiment exemplifies an aspect in which the training device and the other device are implemented by one device.

The detection device and the training device each include a computer device. The computer devices included in the detection device and the training device can be the same as each other, and are the same as each other in this embodiment. Moreover, the detection device and the training device each include peripheral devices connected to the computer device. The peripheral devices can also be the same in both the detection device and the training device, and are the same in this embodiment, although not limited thereto.

<Training Device>

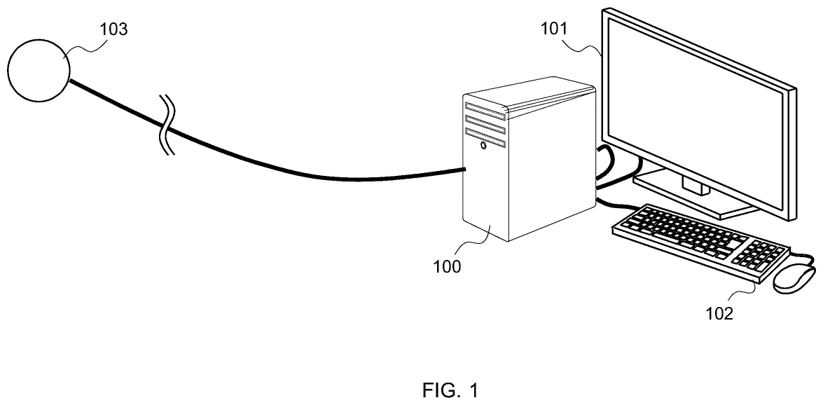

First, a hardware configuration of the training device is illustrated in FIG. 1, and a hardware configuration of the detection device is also the same. The training device includes the computer device and the peripheral devices both of which are illustrated in FIG. 1.

The computer device is denoted by 100. A display 101 and an input device 102 are connected to the computer device 100. Moreover, a microphone 103 is connected to the computer device 100 as described later.

The display 101 is for displaying still images or videos, and a publicly-known or well-known display can be used. Although the display 101 in this embodiment can display both still images and videos, the display 101 is not required to display both. A publicly-known or well-known display can be used as the display 101, and a commercially available display is sufficient. The display 101 is a liquid crystal display, for example. The display 101 in this embodiment is connected to the computer device 100 with cable in a wired manner, but may be connected to the computer device 100 in a wireless manner. In addition, as a technology used for connecting the computer device 100 and the display 101, a publicly-known or well-known technology can be used.

The input device 102 is used by a user to make desired input to the computer device 100. As the input device 102, a publicly-known or well-known input device can be used. Although the input device 102 of the computer device 100 in this embodiment is a keyboard, the input device 102 is not limited thereto. A publicly-known or well-known input technology such as voice input, which uses a numeric keypad, a track ball, a mouse, and/or a microphone terminal, can also be used. In the case in which the display 101 is a touch panel, the display 101 also serves as the input device 102.

The microphone 103 is connected to the computer device 100. The microphone 103 has a function of collecting a sound including a sound from an object, which is one of vibration generated from the object described below, and generating sound data that is data of the collected sound. As the microphone 103, a publicly-known or well-known microphone can be used as long as the microphone has the above-mentioned function, and a commercially available microphone is sufficient. The sound data about the sound generated by the microphone 103 is sent from the microphone 103 to the computer device 100 via cable. The method for sending the sound data from the microphone 103 to the computer device 100 may be wireless, not wired. Further, transmission of the sound data from the microphone 103 to the computer device 100 may be performed via the Internet. In addition, the above-mentioned transmission of the sound data from the microphone 103 to the computer device 100 in a wired manner or a wireless manner or via the Internet is not necessarily performed in approximately real time. For example, it suffices that the sound data generated by the microphone 103 is recorded in a recording medium in a device that has no relationship with the computer device 100 once, and the sound data recorded in the recording medium may be read into the computer device 100 directly or via another recording medium, thereby being supplied to the computer device 100. That is, it is essential to send the sound data generated by the microphone 103 to the computer device 100, but the method and timing of sending the sound data can be determined as appropriate depending on circumstances.

An amplifier for amplifying the sound data may be arranged between the microphone 103 and the computer device 100. As a matter of course, the amplifier is publicly known or well known, and there are many commercially available amplifiers. Therefore, when the amplifier is used, an appropriate one of the amplifiers may be selected and used. Although the amplifier is used in this embodiment, the detailed description thereof is omitted because that amplifier is ordinary.

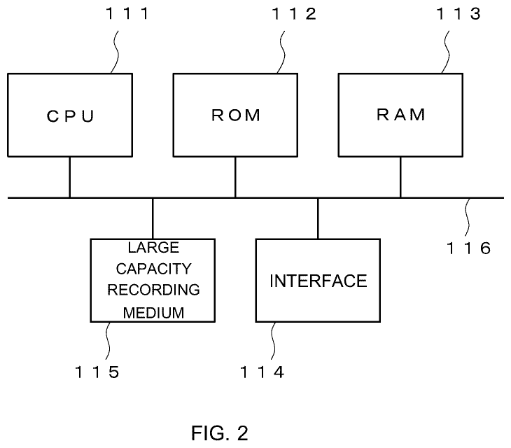

Next, a configuration of the computer device 100 forming the training device is described. FIG. 2 shows a hardware configuration of the computer device 100.

The hardware includes a central processing unit (CPU) 111, a read only memory (ROM) 112, a random access memory (RAM) 113, an interface 114, and a large capacity recording medium 115, which are mutually connected by a bus 116.

The CPU 111 is an arithmetic operation device that performs arithmetic operations. The CPU 111 performs processing described later by, for example, executing a computer program recorded in the ROM 112 or the RAM 113. The large capacity recording medium 115 is a publicly-known or well-known device for recording therein a large amount of data and is, for example, a hard disk drive (HDD) or a solid state drive (SSD). The above-mentioned computer program may be recorded in the large capacity recording medium 115, and is rather general.

The computer program described here includes a computer program for causing the computer device 100 to perform processing, which is described later, required for causing the computer device 100 to function as the training device. This computer program may be preinstalled or post-installed in the computer device 100. Installation of this computer program into the computer device 100 may be performed via a predetermined recording medium such as a memory card, which is not shown, or via a network such as a LAN or the Internet. As a matter of course, in addition to the above-mentioned computer program, a required computer program such as an OS may be included in the examples of the computer program.

The ROM 112 has a computer program and data recorded therein, which are required for execution of processing described later by the CPU 111.

The RAM 113 provides a work area required for the CPU 111 to perform processing. In some cases, (at least a part of) the computer program or data described above may be recorded or temporarily recorded in the RAM 113.

The interface 114 enables the CPU 111, the RAM 113, and the like connected by the bus 116 to pass data to the outside and receive data from the outside. The display 101, the input device 102, and the microphone 103 described above are connected to the interface 114.

The data of operation content input from the input device 102 and the sound data sent from the microphone 103 are input to the bus 116 from the interface 114.

Further, data for displaying an image on the display 101 in a well-known manner is sent from the bus 116 to the interface 114 and then output from the interface 114 to the display 101.

A system set including the computer device 100 described above executes processing required for functioning as the training device by the following functional blocks.

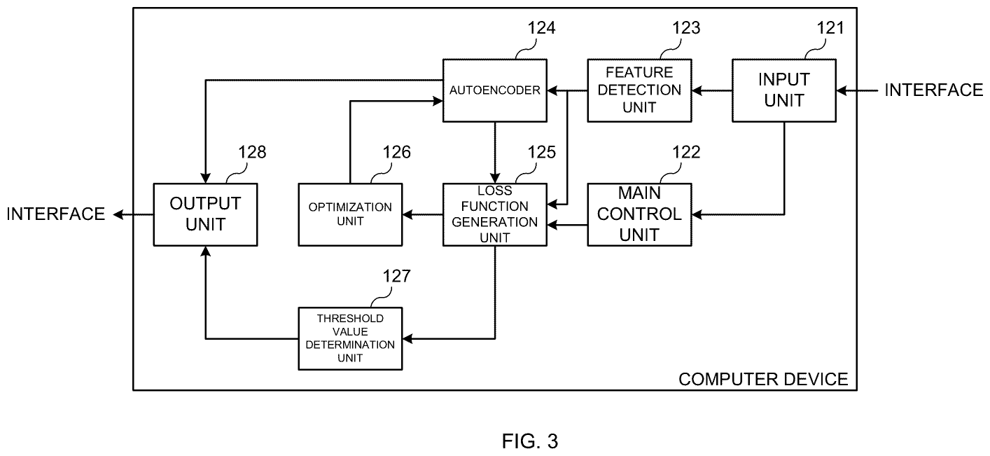

As a result of execution of the computer program by the CPU 111, functional blocks illustrated in FIG. 3 are generated inside the computer device 100. The following functional blocks may be generated by the function of the above-mentioned computer program alone for causing the computer device 100 to perform the processing required for the computer device 100 to function as the training device, which is described later. Instead, the following functional blocks may be generated by cooperation between the above-mentioned computer program and another computer program, such as an OS, installed in the computer device 100.

An input unit 121, a main control unit 122, a feature detection unit 123, an autoencoder 124, a loss function generation unit 125, an optimization unit 126, a threshold value determination unit 127, and an output unit 128 are generated in the computer device 100 in relation to functions of the present embodiments.

The input unit 121 receives input from the interface 114.

An example of the input from the interface 114 to the input unit 121 is input from the input device 102. An example of the input from the input device 102 is mode selection data, the details of which are described later. When the mode selection data or the like is input from the input device 102, the mode selection data or the like input from the input device 102 is sent to the main control unit 122 from the input unit 121. An example of the data input from the interface 114 to the input unit 121 is sound data from the microphone 103. When receiving the sound data, the input unit 121 sends the sound data to the feature detection unit 123. In this embodiment, the input unit 121 also performs required processing for the sound data, for example, processing for converting the sound data from analog data to digital data having a predetermined format (for example, digital data having WAV format) and processing for adjusting the duration of the sound data to a predetermined duration (for example, a planned duration such as 10 seconds and 30 seconds). The sound data thus adjusted is sent from the input unit 121 to the feature detection unit 123 in this embodiment.

The main control unit 122 performs overall control of the above-mentioned functional blocks generated in the computer device 100. For example, the main control unit 122 sometimes receives the mode selection data as described above. The training device in this embodiment is configured to function in one mode alternatively selected from two modes: a training mode in which the training device functions as a training device, and a threshold value determination mode in which the training device functions as a device for determining a threshold value. The mode selection data is data that determines (specifies) in which one of those two modes the computer device 100 is caused to function. The main control unit 122 that has received the mode selection data instructs appropriate one or more of the other functional blocks to execute the selected mode. In this embodiment, at least the main control unit 122 gives an instruction as to an output destination of a loss function (to be precise, data of the loss function) generated by the loss function generation unit 125 in a manner described later to the loss function generation unit 125. More specifically, the main control unit 122 instructs the loss function generation unit 125 to send the data of the loss function to the optimization unit 126 when the training device executes the training mode and to the threshold value determination unit 127 when the training device executes the threshold value determination mode.

The feature detection unit 123 detects a feature of the received sound data and generates sound feature data that is data about the feature of the sound. The sound feature data, which is described in detail later, is a mel-frequency spectrogram (more precisely, data thereof) in this embodiment, although not limited thereto. How to generate the mel-frequency spectrogram is described later. The feature detection unit 123 sends the sound feature data thus generated to the autoencoder 124 and the loss function generation unit 125.

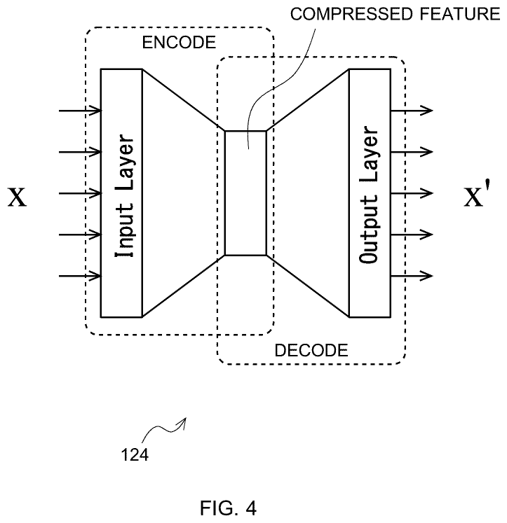

The autoencoder 124 is an autoencoder machine that encodes input data being predetermined data and then decodes the encoded data to obtain data having the same dimensions as those of the input data. Such autoencoders are publicly known or well known in the fields of artificial intelligence. It suffices that the autoencoder 124 in this embodiment is selected from those known autoencoders. The autoencoder 124 is conceptually illustrated in FIG. 4. The autoencoder 124 is configured by a combination of an input layer that receives an input “x”, an intermediate layer that encodes the input “x” to compress a feature and decodes the compressed data to decompress the feature, and an output layer that gives an output x′. The autoencoder 124 sometimes receives the sound feature data from the feature detection unit 123 as described above. When receiving the sound feature data, the autoencoder 124 encodes the sound feature data, then decodes the encoded data to recover the encoded data to the sound feature data, and outputs the sound feature data. The sound feature data thus output is referred to as “estimated sound feature data.” The autoencoder 124 sends the estimated sound feature data thus generated to the loss function generation unit 125.

The autoencoder 124 also sends information on a trained autoencoder itself to the output unit 128 at a timing described later.

The loss function generation unit 125 receives the sound feature data from the feature detection unit 123 and the estimated sound feature data from the autoencoder 124, as described above. In short, the sound feature data and the estimated sound feature data correspond to the input and the output of the autoencoder 124, respectively, when encoding processing and decoding processing are performed once in the autoencoder 124 and form a pair of data. The loss function generation unit 125 generates a loss function in order to obtain a difference between the sound feature data and the estimated sound feature data in one pair. There are publicly-known or well-known loss functions. Among those publicly-known or well-known loss functions, a mean square error (MSE) is used as the loss function in this embodiment, although the loss function is not limited thereto. The reason for using the MSE is to reduce an inference error when the difference between the sound feature data and the estimated sound feature data is excessively large.

When emphasis is placed on making it easy to intuitively recognize values of the loss function during training, a root mean squared error (RMSE) may be used instead of the mean square error. As another loss function, a mean absolute error (MAE) may be used in order to reduce the error mean between the sound feature data and the estimated sound feature data. Similarly, a value that minimizes the mean and variance of the error between the sound feature data and the estimated sound feature data can be employed as the loss function. In this case, the Euclidean distance between the sound feature data and the estimated sound feature data is used as the loss function.

The loss function generation unit 125 sends the generated loss function to the optimization unit 126 when the training device executes the training mode and to the threshold value determination unit 127 when the training device executes the threshold value determination mode.

The optimization unit 126 may receive (data of) the loss function from the loss function generation unit 125 when the training device is executing the training mode, as described above. The optimization unit 126 has a function of adjusting the autoencoder 124 to minimize the loss function. The optimization unit 126 in this embodiment has a function of, when the trained autoencoder 124 has been already prepared, placing the trained autoencoder 124 immediately before receiving the data of the loss function in an initial state, and performing additional training of the autoencoder 124 with regard to added input data, thereby updating the autoencoder 124.

As already known, the autoencoder 124 encodes the input data to compress the feature of the input data and decodes data of the minimized feature to decompress the minimized feature. During the encoding process and the decoding process, the autoencoder 124 uses a plurality of weighting factors. The optimization unit 126 adjusts the plurality of factors in such a manner that, for example, a total of all loss functions including a newly received loss function is minimized. This is the above-mentioned additional training. The autoencoder 124 is thus tuned to minimize the difference between the sound feature data and the estimated sound feature data, when the training device is executing the training mode.

The threshold value determination unit 127 may receive (data of) the loss function from the loss function generation unit 125 when the training device is executing the threshold value determination mode, as described above.

The threshold value determination unit 127 determines a threshold value based on the received loss function and sends (data of) the threshold value to the output unit 128.

It is described later in detail how the threshold value determination unit 127 determines the threshold value.

The threshold value determination unit 127 sends the data of the threshold value to the output unit 128 at a timing described later.

The output unit 128 has a function of outputting required data in the data generated in the functional blocks included in the computer device 100 to the outside via the interface 114.

The output unit 128 may receive the data of the trained autoencoder and the data of the threshold data, as described above. When receiving both, the output unit 128 outputs the received data to the interface 114.

A method of using the training device and an operation thereof are described below.

As described above, the training device alternatively functions in any one of two modes: the training mode and the threshold value determination mode. Therefore, to use the training device, it is required to determine the mode of the training device. A threshold value is determined depending on the characteristics of a trained autoencoder after training in the training mode as described later, and hence the threshold value cannot be determined prior to completion of the trained autoencoder. Therefore, in the training device, the training mode is executed first, and the threshold value determination mode is then executed.

To cause the training device or the computer device 100 to execute the training mode, the mode selection data is input from the input device 102 in the computer device 100 first. The mode selection data selects a mode to be executed by the training device from the above-mentioned two modes. In this case, a user operates the input device 102, and data indicating that the training mode is selected as the mode of the training device is input from the input device 102 as the mode selection data.

The mode selection data is sent to the input unit 121 from the input device 102 via the interface 114, and then reaches the main control unit 122 from the input unit 121. The main control unit 122 having received the mode selection data instructs each functional block to execute the training mode. For example, the main control unit 122 instructs the loss function generation unit 125 to send data of the generated loss function to the optimization unit 126.

In this state, the training mode is executed in the training device.

The microphone 103 has a function of collecting a sound including a sound generated from an object and generating sound data that is data of the collected sound. Therefore, the microphone 103 is arranged at a position at which the microphone 103 can at least sense the sound given from the object. For example, when the object is a machine, the microphone 103 is arranged at a position at which the microphone 103 can sense the sound generated by the machine. When the object is a bridge, the microphone 103 is arranged at a position at which the microphone 103 can sense the sound generated from the bridge when the bridge is struck by something during a hammering test. When the object is a meeting room, the microphone 103 is arranged at a position at which the microphone 103 can collect a sound in the meeting room.

The sound collected by the microphone 103 when the training mode is executed is assumed as a sound when the object is in the stationary state. The sound may include an environmental sound. The definition of the stationary state can be determined by a user who operates the training device as appropriate. The microphone 103 generates sound data that is data of the sound collected or sensed. The sound data is amplified by an amplifier as required and, in this embodiment, is sent to the computer device 100 in the training device, to which the microphone 103 is connected in a wired manner.

The sound data is sent from the interface 114 to the input unit 121 and is adjusted there. As described above, in this embodiment, although not limited thereto, the input unit 121 converts the sound data sent as analog data into digital data having a predetermined format (WAV format in this embodiment, although the format is not limited thereto), and adjusts the duration of the converted data to data having a predetermined duration (for example, 10 seconds or 30 seconds). The predetermined duration is 12 seconds in this embodiment, although not limited thereto.

The sound data thus adjusted is sent from the input unit 121 to the feature detection unit 123.

The feature detection unit 123 detects a feature of the received sound data and generates sound feature data that is data about the feature of the sound.

The sound feature data may have any format, and is a mel-frequency spectrogram, which is publicly known or well known as a data format for representing a feature of a sound, in this embodiment.

As a method for obtaining sound feature data, which is the mel-frequency spectrogram, from the sound data, any publicly-known or well-known method can be employed. For example, the mel-frequency spectrogram can be obtained by converting a file of sound data into power spectrum data by short-time Fourier transform processing (STFT), applying a mel-filter bank to the converted data, and smoothing the data to which the mel-filter bank has been applied by performing a logarithmic operation. As a matter of course, the mel-frequency spectrogram can be obtained by publicly-known or well-known other methods. A delta mel-frequency spectrogram for extracting a difference between previous and subsequent frames in the mel-frequency spectrogram may be detected by the feature detection unit in order to capture a dynamic temporal change of a sound instead of the sound itself having a frequency in the audible range.

In any case, once the sound feature data as the mel-frequency spectrogram is generated, the feature detection unit 123 sends the sound feature data thus generated to the autoencoder 124 and the loss function generation unit 125.

The sound feature data sent from the feature detection unit 123 is input to the autoencoder 124. More specifically, the sound feature data is input to the input layer of the autoencoder 124.

In a state before first sound feature data is input, the autoencoder 124 is a known appropriate autoencoder 124. The autoencoder 124 encodes the sound feature data input thereto and then decodes the encoded data, thereby generating estimated sound feature data.

The autoencoder 124 sends the estimated sound feature data thus generated to the loss function generation unit 125.

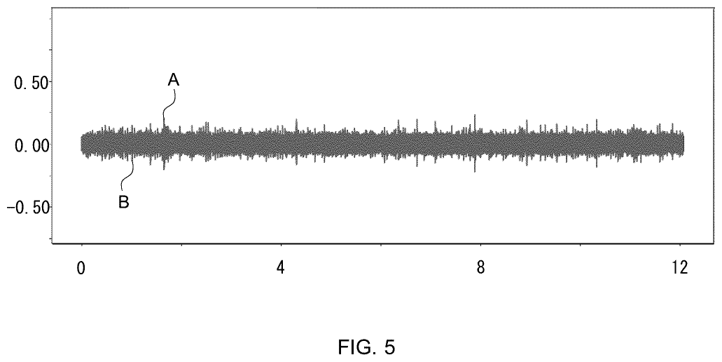

The loss function generation unit 125 receives the sound feature data from the feature detection unit 123 and the estimated sound feature data from the autoencoder 124, as described above. In short, the sound feature data and the estimated sound feature data correspond to the input and the output of the autoencoder 124, respectively, when encoding processing and decoding processing are performed once in the autoencoder 124 and form a pair of data. The loss function generation unit 125 generates a loss function in order to obtain a difference between the sound feature data and the estimated sound feature data in one pair. The loss function generation unit 125 generates a loss function as a mean square error (MSE) in this embodiment, as described above, although not limited thereto. An example of the generated loss function is shown in FIG. 5.

The loss function generation unit 125 sends data of the loss function generated in the above-mentioned manner to the optimization unit 126.

The optimization unit 126 functions so as to minimize the loss function. More specifically, the optimization unit 126 in this embodiment has a function of, when the trained autoencoder 124 has been already prepared, regarding the trained autoencoder 124 as an initial state autoencoder, and performing additional training of the autoencoder 124 with regard to added input data, thereby updating the autoencoder 124.

As already described, the autoencoder 124 includes a plurality of weighting factors used in encoding and decoding. The optimization unit 126 adjusts the plurality of factors in such a manner that, for example, a total value of all loss functions including a newly received loss function is minimized. The adjustment can be achieved by, for example, sending a factor to be changed to the autoencoder 124 from the optimization unit 126 or sending a new set of all the factors to the autoencoder 124 from the optimization unit 126.

While the training device executes the training mode, the computer device 100 forming the training device repeats processing of inputting sound data from the input unit 121 to the feature detection unit 123 to processing executed by the optimization unit 126 to optimize the factors included in the autoencoder 124 to minimize a loss function, that is, processing of additional training.

By repeating this processing a plurality of times, for example, although not limited thereto, about 200 times (counting that all of the sound feature data given in the input processing is used at least once as once), the loss function that is the difference between the sound feature data as the input to the autoencoder 124 and the estimated sound feature data as the output from the autoencoder 124 does not become the same as each other, but becomes small enough to fall within a certain range. The sound data used for training is about a sound including a sound generated when an object is in the stationary state, and hence the autoencoder 124 becomes an autoencoder exclusively for when the object is in the stationary state, and thus has a function of making sound feature data when the object is in the stationary state and estimated sound feature data derived from the sound feature data substantially the same. The autoencoder 124 with its input and output satisfying the above-mentioned relationship when the object is in the stationary state can be said to be a trained autoencoder.

To obtain the trained autoencoder, a lot of sound data is required as described above. Such sound data can be only data about the sound when the object is in the stationary state. It is relatively easy to collect such sound data because the time during which the object is in the stationary state is generally overwhelmingly longer than the time during which the object is in the non-stationary state. Further, when collecting the sound data, it is not required to collect the sound data about a sound in the non-stationary state, and it is not required to collect sound data for different types of sounds in the non-stationary state of multiple levels. In addition, the sound data used for training of the autoencoder 124 is only data in the stationary state, and hence labeling of the sound data is not required. Further, noise canceling processing for the sound data is at least not essential.

In this embodiment, the sound feature data generated from the sound data input from the microphone 103 has been described as being successively input to the autoencoder 124. However, when a lot of sound data is generated and recorded in a recording medium (that may be built in the computer device 100 or may exist outside the computer device 100) in advance, the autoencoder 124 can be caused to perform learning in the same manner as the above-mentioned manner by successively sending the sound data read from the recording medium by the computer device 100 to the feature detection unit 123. Similarly, when a large number of pieces of sound feature data are recorded in a recording medium, the sound feature data is successively supplied to the autoencoder 124, thereby being able to cause the autoencoder 124 to learn in the same manner as the above-mentioned manner. That is, generation of sound data by the microphone 103 and learning of the autoencoder 124 are not required to be performed continuously in time.

After the trained autoencoder is generated in the above-mentioned manner, a threshold value is determined.

The threshold value is to be used in the detection device as described later in determination of whether the sound identified by the sound data input to the detection device in a manner described later has non-stationarity (includes a non-stationary sound).

In determination of the threshold value, the training device or the computer device 100 forming the training device executes the threshold value determination mode as described above. A user inputs the mode selection data indicating that the threshold value determination mode is selected from the input device 102 in the computer device 100.

The mode selection data is sent to the input unit 121 from the input device 102 via the interface 114, and then reaches the main control unit 122 from the input unit 121 as described above. The main control unit 122 having received the mode selection data instructs each functional block to execute the threshold value determination mode. For example, the main control unit 122 instructs the loss function generation unit 125 to send data of the generated loss function to the threshold value determination unit 127.

In this state, the threshold value determination mode is executed in the training device.

Processing in execution of the threshold value determination mode is the same as that in execution of the training mode until a loss function is generated by the loss function generation unit 125. However, sound data used when the threshold value determination mode is executed is sound data of a sound including a stationary sound, but the sound data is required to be different from the sound data used when the training mode is executed, that is, sound data used for training of the autoencoder 124 in order to obtain a trained autoencoder.

For example, when sound data newly generated by the microphone 103 is input to the computer device 100, this sound data is naturally different from the sound data used for training of the autoencoder 124 in order to obtain a trained autoencoder. When this sound data is sound data of a sound including a stationary sound, this sound data can be used when the threshold value determination mode is executed.

The sound data newly input from the microphone 103 is used as sound data not used for learning of the autoencoder 124 in this embodiment, although the sound data not used for learning is not limited thereto.

The sound data is input to the input unit 121, converted to sound feature data that is a mel-frequency spectrogram by the feature detection unit 123, and sent to the trained autoencoder 124 and the loss function generation unit 125, as in the case in which the training mode is executed in the computer device 100. The trained autoencoder 124 outputs estimated sound feature data depending on the sound feature data input thereto and sends the estimated sound feature data to the loss function generation unit 125. The loss function generation unit 125 then generates a loss function from a pair of the sound feature data and the estimated sound feature data input thereto, which correspond to the input and output of the autoencoder 124, respectively.

The generated loss function is sent from the loss function generation unit 125 to the threshold value determination unit 127. The threshold value determination unit 127 having received the loss function determines a threshold value.

For example, the loss function is conceptually shown in FIG. 5, as already described. The loss function shown in FIG. 5 has been generated from the sound data used for training of the autoencoder 124, and hence the current loss function generated from the sound data not used for training of the autoencoder 124 should be different from the one shown in FIG. 5. However, the description is provided assuming that the loss function shown in FIG. 5 is generated currently for the sake of simplicity.

The loss function in FIG. 5 is shown in such a manner that loss values are represented by the vertical axis with the mean thereof set to 0, and time is represented by the horizontal axis. For example, the value of the loss function is 1.69 at the point denoted with reference symbol A in FIG. 5, and is −1.02 at the point denoted with reference symbol B (both numbers may be inaccurate).

By obtaining all values of the loss function at respective points on the horizontal axis in this manner, the mean and variance (or standard deviation) of the values of the loss function described above can be obtained. When the variance or standard deviation is appropriately determined, it is possible to determine what percentage of a large number of values can be included. For example, when the variance is set to 9 (the standard deviation is set to 3), approximately 98% of the large number of values are included in this example. In this case, when a horizontal line is drawn in FIG. 5 at such a height that only 2% of the values exceeds that horizontal line on the positive value side, the coordinate of the height of the horizontal line serves as a threshold value for determining whether an error is truly counted as an error (to what extent the error can be regarded as not being an error) in the detection device described later.

The threshold value is determined in this manner in this embodiment.

The threshold value can also be obtained from a plurality of threshold values obtained by executing the above-mentioned processing a plurality of times based on a plurality of pieces of sound data, for example, as the mean of the plurality of threshold values.

Further, a plurality of threshold values can also be determined from the viewpoint of to what extent the error is regarded as a true error. The threshold value determination unit 127 determines a plurality of threshold values in this embodiment, although not limited thereto.

As described above, the autoencoder 124 becomes the trained autoencoder 124, and the threshold value to be used in the trained autoencoder 124 is determined.

Those are ported to the detection device described later and used therein. Processing of transferring the above-mentioned data from the training device to the detection device or processing of transferring the above-mentioned data from the computer device 100 included in the training device to a computer device included in the detection device may be appropriately performed by a publicly-known or well-known technology.

For example, in response to the input from the input device 102 to the main control unit 122 via the interface 114 and the input unit 121, the main control unit 122 may instruct the autoencoder 124 to send a set of data about the trained autoencoder 124 to the output unit 128 and also instruct the threshold value determination unit 127 to send data of the threshold value to the output unit 128.

If this is the case, the data of trained autoencoder 124 and the threshold value data are sent from the output unit 128 to the interface 114.

Both data is sent from the interface 114 to the computer device 100 included in the detection device via a predetermined cable, for example. Alternatively, both data is recorded from the interface 114 to a recording medium connected thereto, and is sent to the computer device 100 included in the detection device via the recording medium.

<Detection Device>

As already described, the training device and the detection device may be the same as each other in hardware configuration including the peripheral devices, and are practically the same as each other in this embodiment, although not limited thereto.

The detection device includes a computer device 100X having a hardware configuration equivalent to that of the computer device 100 in the training device, and a display 101X equivalent to the display 101 in the training device, an input device 102X equivalent to the input device 102 in the training device, and a microphone 103X equivalent to the microphone 103 in the training device, which are each connected to the computer device 100X.

The computer device 100 and the computer device 100X, the display 101 and the display 101X, the input device 102 and the input device 102X, and the microphone 103 and the microphone 103X may all be equivalent to each other, but may also be completely identical to each other. When the training device includes an amplifier that amplifies sound data, the detection device also includes an amplifier. Those amplifiers may be equivalent to each other, and may be completely identical to each other.

It should be noted that the illustration of the detection device is omitted because the detection device is illustrated only by adding “X” to each reference symbol of FIG. 1.

As described above, the hardware configuration of the computer device 100X of the detection device is equivalent to the hardware configuration of the computer device 100 of the training device.

The computer device X of the detection device includes a CPU 111X, a ROM 112X, a RAM 113X, an interface 114X, and a large capacity recording medium 115X, which are mutually connected by a bus 116X.

In terms of hardware, functions of the CPU 111X, the ROM 112X, the RAM 113X, the interface 114X, the large capacity recording medium 115X, and the bus 116X included in the computer device 100X of the detection device are equivalent or identical to the respective functions of the CPU 111, the ROM 112, the RAM 113, the interface 114, the large capacity recording medium 115, and the bus 116 included in the computer device 100 of the training device. It should be noted that the illustration of the hardware configuration of the computer device 100X of the detection device is omitted because the hardware configuration of the computer device 100X of the detection device is illustrated only by adding “X” to each reference symbol of FIG. 2.

The computer device 100X of the detection device and the computer device 100 of the training device is different from each other only in that a computer program recorded in the ROM 112X or the large capacity recording medium 115X of the computer device 100X of the detection device is different from the computer program recorded in the computer device 100 of the training device. The computer program recorded in the computer device 100X of the detection device includes a computer program for causing the computer device 100X of the detection device to perform processing, described later, required for causing the computer device 100X to function as the detection device.

However, this computer program may be pre-installed or post-installed in the computer device 100X, installation of the computer program into the computer device 100X can be performed via a recording medium or a network, and an OS and another required computer program may be installed in the computer device 100X in addition to the computer program described above, as with the case of the computer device 100 or the computer program installed in the computer device 100.

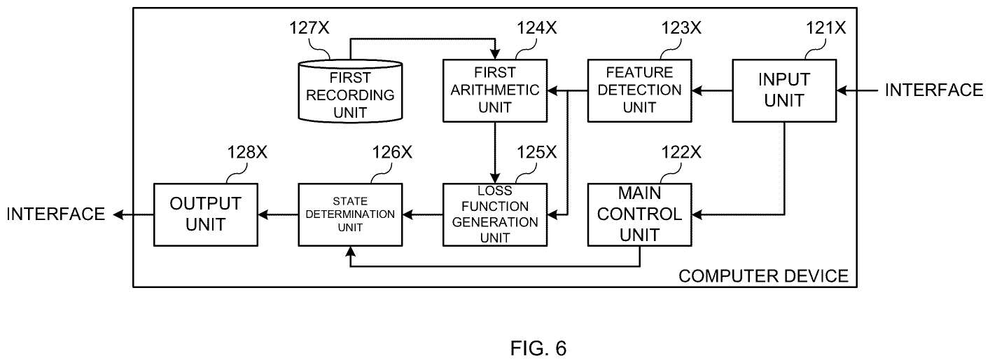

As a result of execution of the computer program by the CPU 111X, functional blocks illustrated in FIG. 6 are generated inside the computer device 100X. The following functional blocks may be generated by the function of the above-mentioned computer program alone for causing the computer device 100X to perform the processing required for the computer device 100X to function as the detection device, which is described later. Instead, the following functional blocks may be generated by cooperation between the above-mentioned computer program and another computer program, such as an OS, installed in the computer device 100.

An input unit 121X, a main control unit 122X, a feature detection unit 123X, a first arithmetic unit 124X, a loss function generation unit 125X, a state determination unit 126X, a first recording unit 127X, and an output unit 128X are generated in the computer device 100 in relation to the functions of the present embodiments (FIG. 6).

The input unit 121X receives input from the interface 114X.

An example of the input from the interface 114X to the input unit 121X is input from the input device 102X. An example of the input from the input device 102X is threshold value setting data, the details of which are described later. When the threshold value setting data is input from the input device 102X, the threshold value setting data is sent to the main control unit 122X from the input unit 121X. An example of the data input from the interface 114X to the input unit 121X is sound data from the microphone 103. When receiving the sound data, the input unit 121X sends the sound data to the feature detection unit 123X. Further, the input unit 121X performs required processing, which is the same as that performed by the input unit 121 in the computer device 100 of the training device, for the sound data in this embodiment, although not limited thereto.

The main control unit 122X performs overall control for the above-mentioned functional blocks generated in the computer device 100X. For example, the main control unit 122X sometimes receives the threshold value setting data, as described above. The main control unit 122X having received the threshold value setting data sends the threshold value setting data to the state determination unit 126X.

The feature detection unit 123X has a function equivalent to the function of the feature detection unit 123 of the computer device 100 of the training device. That is, the feature detection unit 123X detects a feature of the received sound data and generates sound feature data that is data about the feature of a sound. The sound feature data generated by the feature detection unit 123X has the same data format as that of the sound feature data generated by the feature detection unit 123. Therefore, the sound feature data generated by the feature detection unit 123X is a mel-frequency spectrogram in this embodiment, although not limited thereto. The feature detection unit 123X sends the sound feature data thus generated to the first arithmetic unit 124X and the loss function generation unit 125X.

The first arithmetic unit 124X practically functions as the trained autoencoder generated by the training device. Data of the trained autoencoder generated by the training device is recorded in the first recording unit 127X. Every time the first arithmetic unit 124X performs an arithmetic operation described below, the first arithmetic unit 124X reads the data of the trained autoencoder from the first recording unit 127X and serves as the trained autoencoder.

The first arithmetic unit 124X serves as the trained autoencoder, and hence the first arithmetic unit 124X has a function of encoding input data being predetermined data and then decoding the encoded data to obtain data having the same dimensions as those of the input data. That is, the first arithmetic unit 124X functions as an autoencoder machine. In this embodiment, data input to a virtual trained autoencoder existing in the first arithmetic unit 124X is the sound feature data input from the feature detection unit 123X. As with the trained autoencoder 124 in the training device, the first arithmetic unit 124X functioning as the trained autoencoder outputs estimated sound feature data when the sound feature data is input thereto.

The first arithmetic unit 124X sends the estimated sound feature data thus generated to the loss function generation unit 125X.

The loss function generation unit 125X has the same function as that of the loss function generation unit 125 existing in the computer device 100 of the training device.

The loss function generation unit 125X receives the sound feature data from the feature detection unit 123X and the estimated sound feature data from the first arithmetic unit 124X, as described above. In short, the sound feature data and the estimated sound feature data correspond to the input and the output of the autoencoder generated by the function of the first arithmetic unit 124X, respectively, when encoding processing and decoding processing are performed once, and form a pair of data. The loss function generation unit 125X generates a loss function in order to obtain a difference between the sound feature data and the estimated sound feature data in one pair in the same manner as the loss function generation unit 125 in the computer device 100 of the training device.

The loss function generation unit 125X sends data of the generated loss function to the state determination unit 126X.

The state determination unit 126X has a function of, based on the data of the loss function received from the loss function generation unit 125X, determining whether a sound identified by sound data from which the loss function is derived includes a sound indicating that an object is in the non-stationary state (whether the sound is a non-stationary sound) or whether the object giving the sound identified by that sound data is in the non-stationary state. How this determination is made is described later.

When determining that the sound identified by the sound data from which the loss function is derived includes the sound indicating that the object is in the non-stationary state or determining that the object giving the sound identified by that sound data is in the non-stationary state, the state determination unit 126X generates result data indicating the determination result. The result data may be generated only when such determination has been made, but may also be generated when it has been determined that the sound identified by the sound data from which the loss function is derived does not include the sound indicating that the object is in the non-stationary state (that is, the sound is a stationary sound) or the object giving the sound identified by that sound data is not in the non-stationary state (that is, the object in a stationary state).

The state determination unit 126X outputs the generated result data to the output unit 128X.

The output unit 128X has a function of outputting required data in the data generated in the functional blocks included in the computer device 100X to the outside via the interface 114X.

The output unit 128X may receive the result data as described above. When receiving the result data, the output unit 128X outputs the received result data to the interface 114X.

A method of using the detection device and an operation thereof are described below.

When the detection device is used, a threshold value is set first. In the case in which only one threshold value is used and cannot be changed, the only one threshold is used in the detection device. Therefore, processing of setting the threshold value described below is not required.

Setting of the threshold value is performed by a user through an operation of the input device 102X. The user inputs, from the input device 102X, data for specifying a threshold value to be used for detection that an object is in the non-stationary state performed by the detection device. The above-mentioned data for specifying the threshold value is the threshold value setting data. A plurality of types of threshold values can be used in this detection device, as described in the description of the training device, more specifically, the description of the threshold value determination mode. The threshold value setting data is generated as data for selecting one of those threshold values, although not limited thereto. In the case in which the threshold value is not generated in the threshold value determination mode of the training device, for example, the threshold value may be manually input from the input device 102X.

The threshold value setting data is sent from the input device 102X to the input unit 121X via the interface 114X, and then reaches the main control unit 122X from the input unit 121X. The main control unit 122X sends the threshold value setting data to the state determination unit 126X. As a result, the threshold value used in the state determination unit 126X is set in accordance with the threshold value setting data.

The microphone 103X collects a sound including a sound given from the object and generates sound data that is data of the collected sound, as with the microphone 103 included in the training device. The position at which the microphone 103X is arranged corresponds to the position at which the microphone 103 of the training device is arranged.

When the microphone 103X of the detection device collects the sound, it is not known whether the object is in the stationary state or the non-stationary state, and thus the sound collected by the microphone 103X may also be the stationary sound or the non-stationary sound. This is natural due to the nature of the detection device because the detection device detects that the object originally expected to be in the stationary state has become the non-stationary state. Therefore, the sound collected by the microphone 103X may include the sound given by the object in the stationary state or the sound given by the object in the non-stationary state.

The microphone 103X generates sound data that is data of a sound collected or sensed. The sound data is amplified by an amplifier as required and, in this embodiment, is sent to the computer device 100X to which the microphone 103X is connected in a wired manner.

The processing from this point onward until a loss function is generated by the loss function generation unit 125X is the same as the processing in the computer device 100 of the training device until a loss function is generated by the loss function generation unit 125, and the processing conditions such as the specifications of data, the method of generating sound feature data, and the method of generating the loss function are all the same.

The sound data is sent from the interface 114X to the input unit 121X and is adjusted there. In the input unit 121X, the sound data is converted to a 12 second file of WAV format. The sound data thus adjusted is sent from the input unit 121X to the feature detection unit 123X.

The feature detection unit 123X detects a feature of the received sound data and generates sound feature data that is data about the feature of a sound. The feature detection unit 123X generates the sound feature data that is a mel-frequency spectrogram from the sound data in the same method as the method performed by the feature detection unit 123 in the computer device 100 of the training device. A delta mel-frequency spectrogram for extracting a difference between preceding and succeeding frames in the mel-frequency spectrogram may be detected by the feature detection unit in order to capture a dynamic temporal change of a sound instead of a sound itself having a frequency in the audible range.

When the sound feature data as the mel-frequency spectrogram is generated, the feature detection unit 123X sends the sound feature data thus generated to the first arithmetic unit 124X functioning as the trained autoencoder and to the loss function generation unit 125X.

The sound feature data sent from the feature detection unit 123X is input to the trained autoencoder in the first arithmetic unit 124X. As a result, the first arithmetic unit 124X as the trained autoencoder outputs estimated sound feature data.

The estimated sound feature data output from the first arithmetic unit 124X is sent to the loss function generation unit 125X.

The loss function generation unit 125X receives the sound feature data from the feature detection unit 123X and the estimated sound feature data from the first arithmetic unit 124X. The sound feature data and the estimated sound feature data correspond to the input and the output of the autoencoder in the first arithmetic unit 124X, respectively, when encoding processing and decoding processing are performed once in the autoencoder and form a pair of data. The loss function generation unit 125X generates a loss function in order to obtain a difference between the sound feature data and the estimated sound feature data in one pair. The method in which the loss function generation unit 125X generates the loss function is the same as the method in which the loss function generation unit 125 in the computer device 100 in the training device generates the loss function.

The loss function generation unit 125X sends data of the loss function generated in the above-mentioned manner to the state determination unit 126X.

The state determination unit 126X determines, based on the received data of the loss function, whether a sound identified by sound data from which the loss function is derived includes a sound indicating that the object is in the non-stationary state or whether the object giving the sound identified by that sound data is in the non-stationary state.

The determination method is as follows.

As described above, the trained autoencoder included in the first arithmetic unit 124X has been trained well only for the sound (stationary sound) including the sound generated from the object in the stationary state and, when sound feature data (a mel-frequency spectrogram in this embodiment) generated from the stationary sound is input thereto, outputs estimated sound feature data (a mel-frequency spectrogram to be referred to as “estimated mel-frequency spectrogram”) that is almost unchanged from the input sound feature data. Meanwhile, the trained autoencoder included in the first arithmetic unit 124X has not been trained for a sound (non-stationary sound) including a sound generated from the object in the non-stationary state and, when sound feature data generated from the non-stationary sound is input thereto, outputs the estimated sound feature data that is significantly different from the input sound feature data.

Therefore, the loss function corresponding to the difference between the sound feature data and the estimated sound feature data is relatively small in the former case, and relatively large in the latter case.

Accordingly, the state determination unit 126X can distinguish, based on the magnitude of the loss function, whether the object is in the stationary state (the sound input to the microphone 103X is the stationary sound) or the object is in the non-stationary state (the sound input to the microphone 103X is the non-stationary sound).

This is performed through use of the threshold value set in the state determination unit 126X in the above-mentioned manner in this embodiment, although not limited thereto.

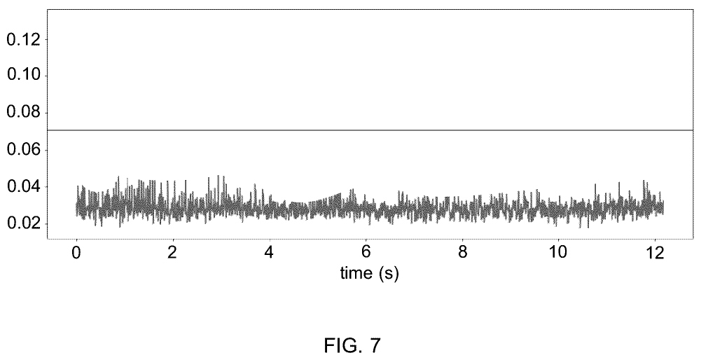

FIG. 7 shows an example of the loss function generated when the object is in the stationary state. In FIG. 7, what the vertical axis and the horizontal axis represent are similar to those in FIG. 5, but values of the loss function in FIG. 7 are shown only in the positive range. In FIG. 7, the horizontal line indicates a threshold value that is 0.07.

In the case in FIG. 7, the loss function has no value exceeding the threshold value. Therefore, as for the loss function shown in FIG. 7, the state determination unit 126X determines that the object is in the stationary state or the sound input to the microphone 103X is the stationary sound (the object does not emit the non-stationary sound).

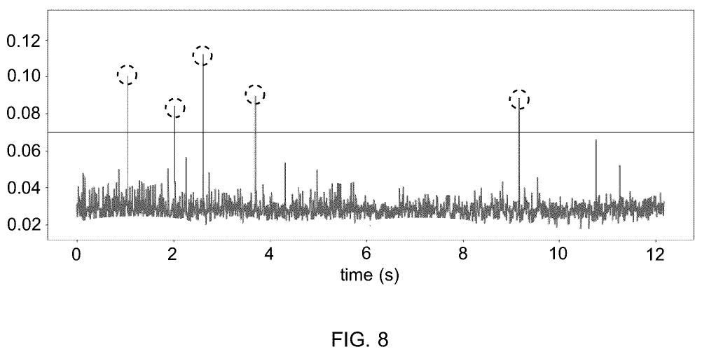

FIG. 8 shows an example of the loss function generated when the object is in the non-stationary state. The illustration manner of FIG. 8 is similar to that of FIG. 7. The threshold value is the same as in the above-mentioned case and is 0.07.

In this case, some values of the loss function exceed the threshold value. Five peaks of the loss function, which are surrounded by broken line, exceed the threshold value. When the loss function exceeds the threshold value at fewer points (e.g., at only one or two points), the value of the loss function which exceeds the threshold value may be considered to be just an error. Based on this, when the loss function has three or more values exceeding the threshold value, the state determination unit 126X in this embodiment determines that the object is in the non-stationary state or the sound input to the microphone 103X is the non-stationary sound, although the determination is not limited thereto. Therefore, as for the loss function shown in FIG. 8, the state determination unit 126X determines that the object is in the non-stationary state or the sound input to the microphone 103X is the non-stationary sound.

As is apparent from the examples shown in FIG. 7 and FIG. 8, the state determination unit 126X can distinguish, by using the loss function and a certain one threshold value, whether the object is in the stationary state (the input sound is the stationary sound) or the object is in the non-stationary state (the input sound is the non-stationary sound).

The sound identified by the sound data input from the microphone 103X can include an environmental sound. This is because, even when the environmental sound is included in the sound identified by the sound data input from the microphone 103X, when the environmental sound has already been learned in the training process of the trained autoencoder, the environmental sound is not reflected as an error of the value of the loss function generated based on the sound data about a sound including the environmental sound.

In the above-mentioned example, the state determination unit 126X determines two levels, specifically, whether the sound data input from the microphone 103X is about the stationary sound or about the non-stationary sound by using one threshold value that is 0.07. Further, the criterion for determining that the sound identified by the sound data is the non-stationary sound used in the above-mentioned example is that “the loss function has three or more values exceeding the threshold value.” By changing the criterion that “the loss function has three or more values exceeding the threshold value,” the above-mentioned determination of the two levels can be changed to determination of three or more levels.

For example, it is assumed that the object is a machine and, when the machine as the object operates normally, no abnormal sound comes from the machine and a sound including an environmental sound at that time is a stationary sound. It is also assumed that when a malfunction occurs in the machine, an abnormal sound is mixed with the sound coming from the machine, and the ratio of the abnormal sound increases in accordance with the degree of deterioration of the malfunction of the machine. In such a case, the number of values of the loss function exceeding the threshold value increases in accordance with the degree of deterioration of the malfunction of the machine. Therefore, it is possible to distinguish four levels of the degree of the machine malfunction through use of the loss function generated based on the sound data by: setting “the loss function has two or less values exceeding the threshold value” as a criterion for determining that the machine as the object is normal (not in the non-stationary state); regarding all cases in which the loss function has three or more values exceeding the threshold value as a state in which the machine as the object is not normal (in the non-stationary state); setting “the number of values of the loss function exceeding the threshold value is between 3 and 9, inclusive” as a criterion for determining a non-stationary state 1 (the machine as the object is in a slightly bad state); setting “the number of values of the loss function exceeding the threshold value is between 10 and 49, inclusive” as a criterion for determining a non-stationary state 2 (the machine as the object is in a very bad state); and setting “the number of values of the loss function exceeding the threshold value is 50 or more” as a criterion for determining a non-stationary state 3 (the machine as the object is in such a bad state that the machine is required to be shut down), for example. The number of threshold values required in such determination is only one.

As a matter of course, three or more levels can be distinguished through use of the loss function generated based on the sound data, also by changing the threshold value as described above. For example, when a threshold value different from the above-mentioned threshold value of 0.07 is made smaller, the range in which it is determined that the object is in the stationary state naturally becomes smaller. Therefore, also when the difference of the sound identified by the sound data from the sound in the stationary state is smaller, the state of the object is detected as the non-stationary state. In contrast, when the threshold value is made larger than 0.07, the range in which the object is determined to be in the stationary state is naturally increased. Therefore, unless the difference of the sound identified by the sound data from the sound in the stationary state becomes larger, the state of the object is not detected as the non-stationary state. The number of levels identified by the sound data can be set to three or more levels based on which threshold value is applied to detect the non-stationary state.

The state determination unit 126X generates result data in accordance with the determination result.

The state determination unit 126X performs determination of two levels in this embodiment, although not limited thereto.

The result data may or may not be generated only when it has been determined that the object is in the non-stationary state or the sound input to the microphone 103X includes the non-stationary sound. In this embodiment, it is assumed that the result data is generated only when it has been determined that the object is in the non-stationary state or the sound input to the microphone 103X is the non-stationary sound, although generation of the result data is not limited thereto.

The result data generated when it has been determined that the object is in the non-stationary state or the sound input to the microphone 103X is the non-stationary sound may include only data indicating that it has been determined that the object is in the non-stationary state or the sound input to the microphone 103X is the non-stationary sound, or may include, in addition to such data, the number of values of the loss function exceeding the threshold value (“5” in the example of FIG. 8), for example.

The result data is used as required.

The state determination unit 126X sends the result data to the output unit 128X in this embodiment, although not limited thereto. The output unit 128X outputs the result data to another device outside the computer device 100X via the interface 114X.

The other device is, for example, a device that sends emails. When receiving the result data, the other device can send an email including the content identified by the result data (for example, the content that the object is in the non-stationary state) to a pre-registered email address. The other device is a patrol lamp and, when the result data is received, sound to inform surrounding people that the object is in the non-stationary state. As a matter of course, the means for informing the surrounding people that the object is in the non-stationary state is not limited to the patrol lamp.

In the case in which the computer device 100X has a function of sending emails, for example, the result data is not required to be output from the computer device 100X to the external device.

In addition, by accumulating the result data in time series, it is also possible to use the result data in order to predict how the state of the object will change in the future or to perform ex-post verification of how the object has changed in the past. For example, a case is considered in which “the number of values of the loss function which exceed the threshold value (“5” in the example of FIG. 8)” included in the result data has been recorded in time series. In this case, when the number has changed in the order of 2, 1, 2, 2, 2, 3, 4, 3, 5, 15, 30, and 48, it is obvious that the non-stationary state of the object rapidly deteriorates in the future. When the result data is used for such a purpose, it is preferred that the result data be recorded in a recording medium in or outside the computer device 100X in a time-series manner, for example, with time stamps attached thereto. When there is a collection of the result data recorded in time series, it is possible to predict the future in real time as to how the object will change, or to perform ex-post verification as to how the object has changed in the past.

### Second Embodiment

A detection device in a second embodiment of the present embodiments is roughly the same as the detection device in the first embodiment.

The difference is as follows. The detection device in the first embodiment uses a sound including a sound from an object as one aspect of vibration as a material for determining whether the object is in the stationary state or the non-stationary state, whereas the detection device in the second embodiment uses vibration transmitted from a solid (for example, vibration including vibration from the object which can be detected by a vibration sensor attached to a housing of a machine as the object) as the material for determining whether the object is in the stationary state or the non-stationary state.

A trained autoencoder to be included in the detection device is also required in the second embodiment, and hence required devices in the second embodiment are also the detection device and the training device as in the first embodiment. Further, when processing using a threshold value is also performed in the detection device in the second embodiment, a device for determining the threshold value is also required in addition to the detection device and the training device described above, as in the first embodiment. However, as in the first embodiment, any two of those three devices can be integrated into one device, or all of those three devices can be integrated into one device.

In the second embodiment, it is determined whether the object is in the stationary state or the non-stationary state based on vibration by the training device also having a function of the device for determining the threshold value and the detection device, as in the first embodiment, although how to perform such determination is not limited thereto.

<Training Device>

The training device in the second embodiment is roughly the same as the training device in the first embodiment, and the overall hardware configuration thereof is illustrated in FIG. 1.

A clear difference is that the microphone 103 in the first embodiment is replaced with a vibration sensor.

The vibration sensor may be a publicly-known or well-known vibration sensor, and can be appropriately selected in accordance with the frequency and, in some cases, the amplitude of vibration to be sensed. While data generated by the microphone 103 is sound data about a collected sound, data generated by the vibration sensor is vibration data that is data in accordance with the vibration sensed by the vibration sensor. The vibration data is amplified by an amplifier as required, as in the first embodiment, and is sent to the computer device 100.

The training device in the second embodiment also includes the computer device 100.

The computer device 100 in the second embodiment is equivalent to the computer device 100 in the first embodiment in the hardware configuration and may be completely identical to each other.

Functional blocks that are the same as those in the first embodiment illustrated in FIG. 3 are generated in the computer device 100 in the second embodiment. The function of each functional block generated in the computer device 100 in the second embodiment is basically the same as the function of the corresponding functional block generated in the computer device 100 in the first embodiment.

The difference is a feature detected by the feature detection unit 123. The feature detection unit 123 in the second embodiment uses, as a feature of vibration identified by vibration data, a frequency spectrogram (amplitude spectrum) from time-series data extracted by sampling data with a window width, instead of the mel-frequency spectrogram used in the first embodiment.

As a method for obtaining vibration feature data that is a frequency spectrogram (amplitude spectrum) from time-series data extracted by the sampling data with a window width from the vibration data, any publicly-known or well-known method can be employed. For example, the frequency spectrogram (amplitude spectrum) can be obtained by performing normalization processing for a file of the vibration data and further performing Fourier transform processing (FFT) for the data to convert the data into power spectrum data. As a matter of course, the frequency spectrogram (amplitude spectrum) can be obtained in other publicly-known or well-known methods.

When the training mode described in the first embodiment is executed in the computer device 100 in the second embodiment, vibration sensed by the vibration sensor is only stationary vibration that is vibration including vibration from the object in the stationary state, and thus vibration data input to the computer device 100 in the second embodiment when the training mode is executed is vibration data about stationary vibration.

Although the sound feature data is replaced with the vibration feature data, the vibration feature data generated by the feature detection unit 123 based on the vibration data is input to the autoencoder 124 also in the second embodiment, as in the first embodiment. As a result, the autoencoder 124 outputs estimated vibration feature data corresponding to the estimated sound feature data in the first embodiment.

In the first embodiment, the sound feature data and the estimated sound feature data that correspond to one input and one output of the autoencoder 124 are sent to the loss function generation unit 125 which, in turn, generates a loss function corresponding to loss between the sound feature data and the estimated sound feature data. To correspond to this operation, in the second embodiment, the vibration feature data and the estimated vibration feature data that correspond to one input and one output of the autoencoder 124 are sent to the loss function generation unit 125 which, in turn, generates a loss function corresponding to loss between the vibration feature data and the estimated vibration feature data.

Also in the second embodiment, the optimization unit 126 functions to minimize such a loss function as in the first embodiment, thereby causing factors in the autoencoder 124 to be adjusted in an appropriate manner.

By repeating the above-mentioned processing a plurality of times, usually many times, the autoencoder 124 in the second embodiment also eventually becomes the trained autoencoder 124 as in the first embodiment. The trained autoencoder 124 in the second embodiment can be said to be the autoencoder 124 exclusively for stationary vibration which has been tuned in such a manner that the vibration feature data and estimated vibration feature data corresponding to one input and one output are substantially the same as each other only when vibration data input to the computer device 100 is vibration data about stationary vibration.

Further, a threshold value determination mode that is similar to that in the first embodiment is also performed in the computer device 100 in the second embodiment.

Data input when the computer device 100 in the second embodiment executes the threshold value determination mode is vibration data about stationary vibration that has not been used for training of the trained autoencoder 124.

The threshold value determination mode in the second embodiment is basically the same as that in the first embodiment. Except that sound data, sound feature data, and estimated sound feature data are replaced with vibration data, vibration feature data, and estimated vibration feature data, respectively, the threshold value determination mode is not changed between the first embodiment and the second embodiment.

The threshold value determination unit 127 in the second embodiment functions in a similar manner to that in the first embodiment with respect to the loss function generated by the loss function generation unit 125. Consequently, a threshold value can be determined also in the computer device 100 in the second embodiment in a similar manner to that in the first embodiment.

<Detection Device>

Next, a detection device in the second embodiment is described.

Also in the second embodiment, the detection device includes the computer device 100X. Further, the detection device in the second embodiment includes peripheral devices that are the same as those of the training device in the second embodiment.

The computer device 100X in the second embodiment is equivalent to the computer device 100X in the first embodiment in the hardware configuration and may be completely identical to each other.

Functional blocks that are the same as those in the first embodiment illustrated in FIG. 6 are generated in the computer device 100X in the second embodiment. The function of each functional block generated in the computer device 100X in the second embodiment is basically the same as the function of the corresponding functional block generated in the computer device 100X in the first embodiment.

The difference is a feature detected by the feature detection unit 123X. The feature detection unit 123X in the computer device 100X in the second embodiment uses, as a feature of vibration identified by vibration data, a frequency spectrogram (amplitude spectrum), as with the feature detection unit 123 in the computer device 100 included in the training device in the second embodiment. The method for obtaining vibration feature data that is the frequency spectrogram (amplitude spectrum) from the vibration data is the same as the method used in the feature detection unit 123 in the second embodiment.

The method of determining whether the object is in the stationary state or the non-stationary state based on vibration in the computer device 100X included in the detection device in the second embodiment is roughly the same as that in the first embodiment.

Also in the second embodiment, vibration sensed by the vibration sensor when the detection device performs such determination may not be only stationary vibration that is vibration including vibration generated by the object in the stationary state, but may also be non-stationary vibration that is vibration including vibration generated by the object in the non-stationary state, as in the first embodiment.

In the second embodiment, based on the vibration data input to the computer device 100X, vibration feature data is generated in the feature detection unit 123X. The vibration feature data is input to the first arithmetic unit 124X. Thus, the vibration feature data is input to the trained autoencoder included in the first arithmetic unit 124X, and as a result, estimated vibration feature data is output from the trained autoencoder.

The vibration feature data and the estimated vibration feature data that correspond to one pair of input and output in the trained autoencoder are input to the loss function generation unit 125X which, in turn, generates a loss function as in the first embodiment. The loss function is sent to the state determination unit 126X.

The state determination unit 126X in the computer device 100X in the second embodiment has a threshold value set therein as in the first embodiment. The state determination unit 126X applies the threshold value to the loss function received from the loss function generation unit 125X, thereby determining whether vibration sensed by the vibration sensor when the vibration data from which the loss function is derived is generated is non-stationary vibration that is vibration when the object is in the non-stationary state or whether the object at that time is in the non-stationary state by a similar procedure to that in the first embodiment.

When determining that vibration sensed by the vibration sensor when the vibration data from which the loss function is derived is generated is non-stationary vibration that is vibration when the object is in the non-stationary state or determining that the object at that time is in the non-stationary state, the state determination unit 126X in the second embodiment generates result data corresponding to that in the first embodiment.

The result data may be generated even when the above-mentioned determination has not been performed, as in the first embodiment.

Moreover, the result data can be used as in the first embodiment. The result data is output from the output unit 128X to the outside of the computer device 100X as required, or is recorded in or outside the computer device 100X.

Test examples are described below.

The test examples described below were performed through use of the detection device described in the first embodiment having data of a trained autoencoder that has been trained by a training mode executed in the training device described in the first embodiment. The threshold value used in the detection device was determined by a threshold value determination mode executed in the training device described in the first embodiment.

### Test Example 1: Detection of Non-Stationary Sound Generated from Cutting Blade of Electric Drill

A cutting blade of an electric drill deteriorates with time of use of the electric drill, and is eventually required to be replaced because of chipping or the like. A test was performed regarding whether such deterioration of the cutting blade of the electric drill was able to be detected from sound data of a sound including a cutting sound (a sound including an environmental sound and the cutting sound).

The training device and the detection device described in the first embodiment were used in Test Example 1.

Prior to performing Test Example 1, sounds generated from the cutting blade of the drill were defined as follows. A sound including a cutting sound of level 1 (sound including an environmental sound) is the stationary sound described in the first embodiment, and sounds including cutting sounds of levels 2 to 5 are the non-stationary sound described in the first embodiment.

Level 1: cutting sound generated from a new cutting blade

Level 2: cutting sound generated from a cutting blade before replacement (cutting malfunction does not occur) but when the replacement time is near

Level 3: cutting sound generated from a cutting blade that has reached the replacement time and is in an initial stage in which a cutting failure occurs

Level 4: cutting sound generated from a cutting blade that has reached the replacement time and is in a state in which a cutting failure frequently occurs

Level 5: cutting sound generated from a cutting blade required to be replaced

Files (WAV format files) of sound data were prepared for the above-mentioned sounds including the cutting sounds of levels 1 to 5. As for the sound including the cutting sound of level 1, one sample (sound data file duration: 12 seconds, sampling rate: 44.1 kHz, bit depth: 16 bit, monaural) was prepared as training data for training, although a large number of sounds can be collected. As for each of sounds including the cutting sounds of levels 2 to 5, occurrence of which is a rare abnormal event, one sample (sound data file duration: 12 seconds, sampling rate: 44.1 kHz, bit depth: 16 bit, monaural) was prepared as test data.

In the training device, an autoencoder was repeatedly trained through use of only sound data about the sound including the sound of level 1, and thus a trained autoencoder was obtained. Sound feature data is a mel-frequency spectrogram. A loss function is a mean square error (MSE).

In this trained autoencoder, for the sound including the sound of level 1, sound feature data that was generated from sound data about the sound (stationary sound) and was input to the trained autoencoder and estimated sound feature data output from the trained autoencoder in response to the input almost matched each other, and values of the loss function became small as a whole.

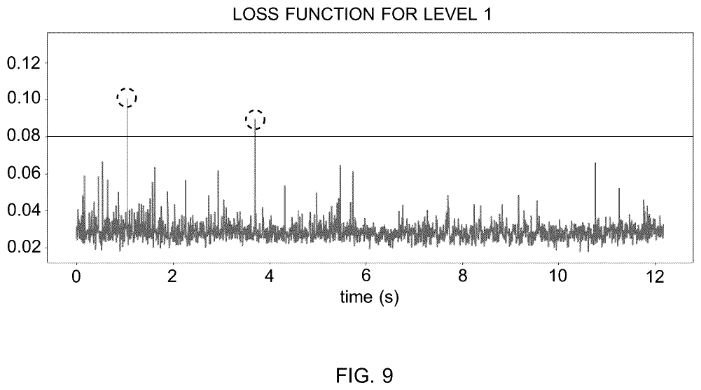

Although it is possible to execute the threshold value determination mode in the training device and determine the threshold value by using a file of sound data about a sound including the sound of level 1 which has not been used for training of the trained autoencoder, the threshold value was set in this test by using the values of the loss function using the sound data file about the sound including the sound of level 1 which has been learned. When the computer device 100 of the training device was caused to read this sound data file and generate the loss function, the loss function shown in FIG. 9 was obtained. The illustration manner of FIG. 9 is similar to that of FIG. 8. The values of the loss function were generally less than 0.10. A threshold value of 0.08 was determined from the mean (0.00) of the loss function and the standard deviation (σ) of the loss function as a threshold value satisfying σ=3, although the value of the loss function exceeds 0.08 at two points each surrounded by a broken line circle.

Accordingly, a criterion was set in the detection device so as to determine that an object was in the non-stationary state when the loss function had three or more values exceeding 0.08 as the threshold value.

The trained autoencoder and the threshold value described above were applied to the detection device. Then, the detection device was caused to read files of sounds including the cutting sounds of levels 2 to 5, and generated loss functions were observed.

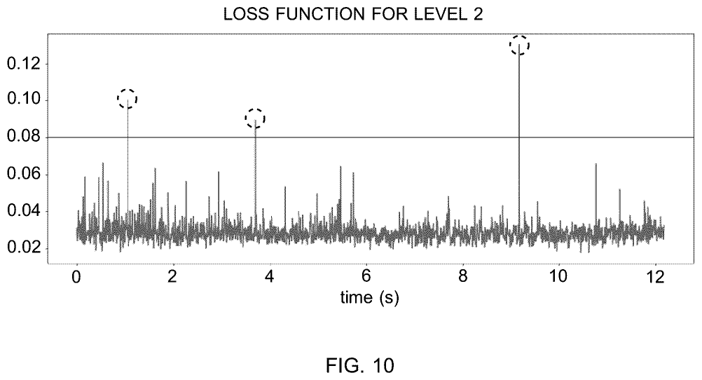

When the sound data file of the sound including the cutting sound of level 2 was input to the computer device 100 of the detection device, the loss function shown in FIG. 10 was generated, for example. The illustration manner of FIG. 10 is similar to that of FIG. 8. That is, values of the loss function were generally less than 0.1 as a whole. However, there were values exceeding 0.08 as the threshold value, the number of which was three or more. As a result, the detection device determined that the input sound including the cutting sound was the non-stationary sound.

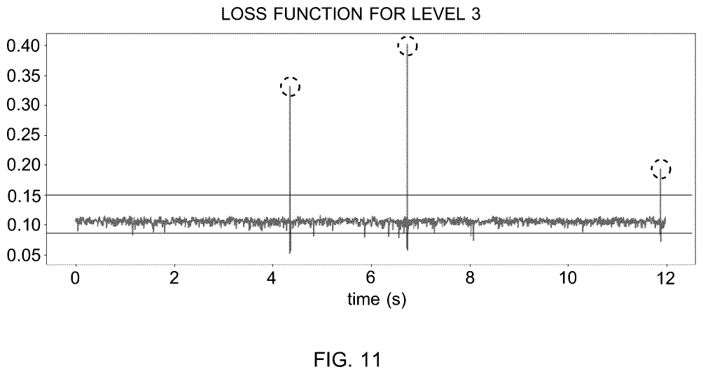

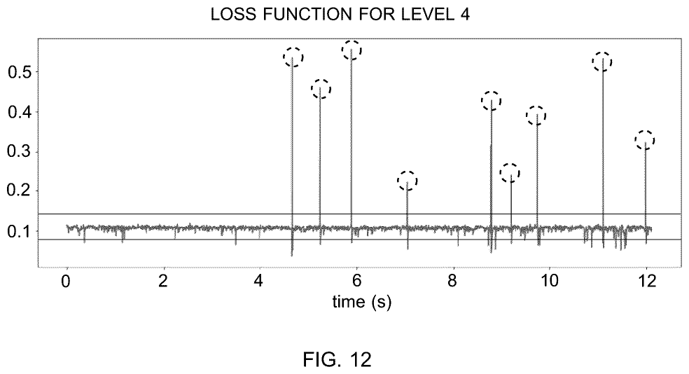

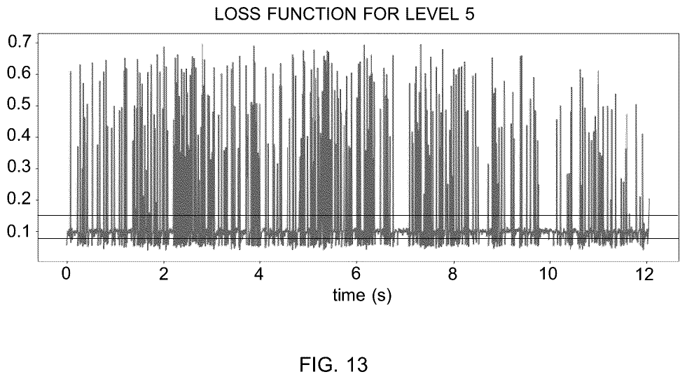

Similarly, when the sound data files of the sounds including the cutting sounds of level 3 to 5 were input to the computer device 100 of the detection device, the loss functions shown in FIG. 11, FIG. 12, and FIG. 13 were generated, for example. The illustration manner of each of FIG. 11, FIG. 12, and FIG. 13 is similar to that of FIG. 8. That is, the number of values of the loss function exceeding 0.08 as the threshold value was large when the sound data of the sound including the cutting sound of level 3 was input, and was innumerable when the sound data of the sound including the cutting sound of level 4 or 5 was input. As a result, in the detection device, it was determined that the sound including the cutting sound input to the computer device 100 of the detection device was the non-stationary sound in all cases in which the sound data files of the sounds including the cutting sounds of levels 3 to 5 were input.

More specifically, when each of the sound data files of the sounds including the cutting sounds of levels 3 to 5 was input to the computer device 100 of the detection device to cause generation of a loss function, it was determined that the sound including the cutting sound was the non-stationary sound in all the cases. As described above, all the sounds including the cutting sounds of levels 3 to 5 were correctly determined as the non-stationary sound.

As described above, when the sound data of sounds including the cutting sounds of levels 2 to 5 was input to the detection device, the number of the values of the loss function exceeding 0.08 as the threshold value was three or more in all the cases, and thus the sound including the cutting sound was correctly determined to be the non-stationary sound in all the cases. In addition, as the level increased from level 2 to level 5, the number of the values of the loss function exceeding 0.08 as the threshold value increased. Therefore, it was found that the level of the input sound including the cutting sound can be determined based on the number of the values.

However, in the case in which the sound data of sounds including the cutting sounds of levels 3 to 5 was input to the detection device, the number of the values of the loss function exceeding 0.08 as the threshold value was so large that the sound identified by the sound data can be determined to be non-stationary sound, but it is difficult to distinguish which one of levels 3 to 5 the level of the identified non-stationary sound is.

Therefore, in Test Example 1, when the sound data of sounds including the cutting sounds of levels 3 to 5 is input to the detection device and the number of the values of the loss function exceeding 0.08 as the threshold value exceeds a predetermined number (for example, 30), a threshold value larger than 0.08 is applied. In that case, a threshold value of 0.15 was applied in Test Example 1, although the larger threshold value is not limited thereto.

Then, in the loss function generated when the sound data of the sound including the cutting sound of level 3 was input to the detection device, the number of values exceeding 0.15 as the threshold value was three (portions each surrounded by a broken line circle in FIG. 11). In the loss function generated when the sound data of the sound including the cutting sound of level 4 was input to the detection device, the number of values exceeding 0.15 as the threshold value was nine (portions each surrounded by a broken line circle in FIG. 12). In the loss function generated when the sound data of the sound including the cutting sound of level 5 was input to the detection device, the number of values exceeding 0.15 as the threshold value was large. For example, the detection device is configured to, in the case in which the number of values of the loss function exceeding 0.15 as the threshold value is 2 to 5, 6 to 20, or 21 or more, determine the cutting sound included in the sound identified by the sound data input thereto when the loss function is generated as the cutting sound of level 3, 4, or 5, respectively. It was found that, with use of this rule (algorithm) and the new threshold value of 0.15, it is possible to determine which one of levels 3 to 5 the level of the cutting blade producing the sound identified by the sound data was.

### Test Example 2: Detection of Non-Stationary Sound During Meeting

Next, assuming that a meeting room during a meeting was an object, a test as Test Example 2 was performed regarding whether a non-stationary sound generated from the object was able to be detected (whether it was possible to detect that the meeting room was in the non-stationary state).

The training device and the detection device described in the first embodiment were used in Test Example 2.

In the meeting room during a meeting, speaking voices of participants of the meeting, a sound of turning paper, a sound of coughing, a sound of pulling a chair, and the like occur on a daily basis. In addition, there may be a fire station near the meeting room used for the test. In such a case, the sound of a siren coming from the fire station frequently enters the meeting room. All the sounds were defined as a sound including a stationary sound generated from the meeting room as the object, and an autoencoder was pre-trained with data of sounds including the stationary sound, thereby obtaining a trained autoencoder. Note that, a sound generated when a pencil is dropped in the meeting room is defined as a non-stationary sound generated from the meeting room in this test, and sound data including the sound generated when the pencil is dropped is not included in the sound data used for pre-training.

Sound feature data used when training in the training device was a mel-frequency spectrogram. A loss function was a mean square error (MSE). In Test Example 2, a threshold value determination mode was not performed in the training device. Therefore, in Test Example 2, automatic determination of the threshold value was not performed.

Meanwhile, data of a sound in the meeting room which was not used in pre-training of the autoencoder and was a sound in a state in which the sound of a siren entered the meeting room was prepared as Sample 1.

Further, data of a sound in the meeting room which was not used in pre-training of the autoencoder and was a sound when the sound of the siren did not enter the meeting room but a pencil was dropped twice was prepared as Sample 2.

Data of stationary sound used for pre-training was one-hour data (sampling rate: 44.1 kHz, bit depth: 16 bit, monaural) of sounds in the meeting room during a normal meeting including a time period in which the siren sound enters the room. Meanwhile, as for each of Sample 1 and Sample 2 each of which is data of sounds in the meeting room not used for pre-training, one piece of data was prepared. The specification of the data is as follows: the duration of the audio file is 60 seconds, the sampling rate is 44.1 kHz, the bit depth is 16 bit, and the audio is monaural.

The above-mentioned one-hour data when the meeting room was in the stationary state was divided into one-minute data, and 60 pieces of one-minute data in total were repeatedly input to the computer device 100 in the training device in the first embodiment, thereby causing the autoencoder to be pre-trained, and a trained autoencoder was obtained.

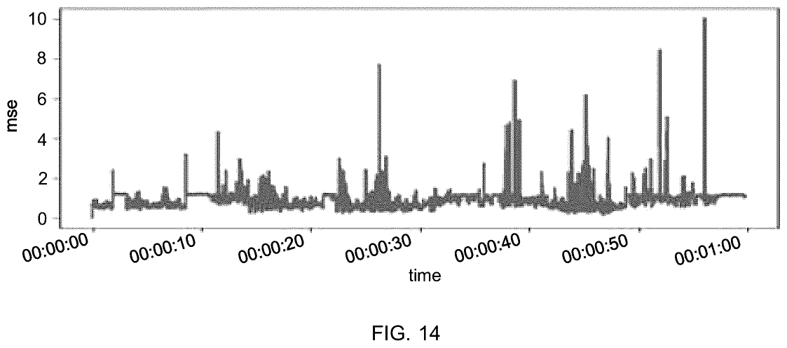

FIG. 14 shows an example of a loss function generated from the sound data used for pre-training when the meeting room is in the stationary state. The illustration manner of FIG. 14 is similar to that of FIG. 8. That is, values of the loss function were generally less than 10 as a whole, and rarely exceeded 16. The trained autoencoder was trained so as to generate a pair of sound feature data and estimated sound feature data providing such a loss function.

Thereafter, a loss function generated by inputting the sound data of each of Sample 1 and Sample 2 to the computer device 100X in the detection device in the first embodiment with the above-mentioned trained autoencoder incorporated was observed.

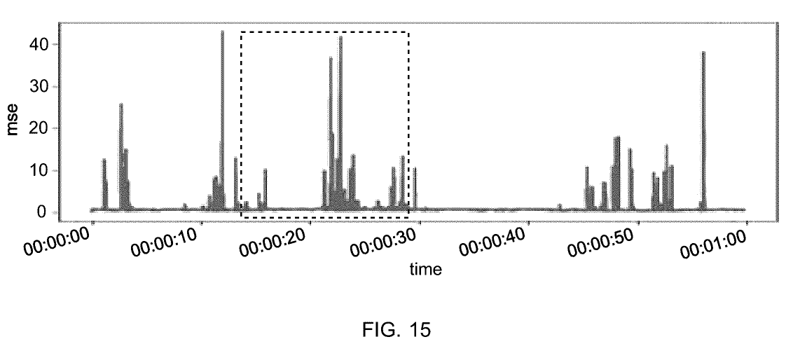

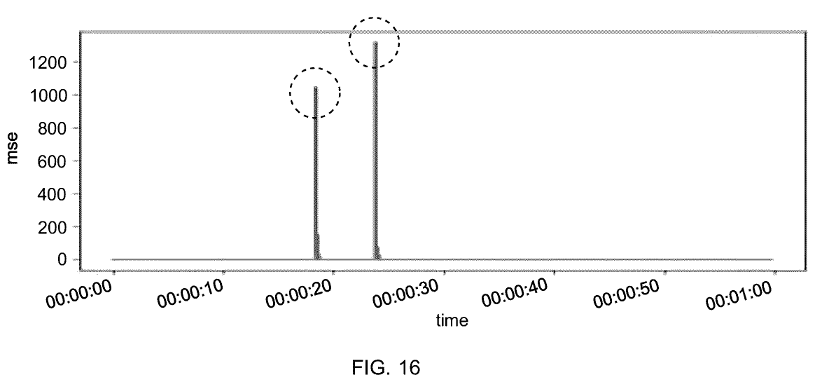

The loss functions generated by inputting the sound data of Sample 1 and Sample 2 to the detection device in the present application are shown in FIG. 15 and FIG. 16. The illustration manner of each of FIG. 15 and FIG. 16 is similar to that of FIG. 8.

In the loss function shown in FIG. 15, a portion surrounded by a broken line represents a state in which the sound of a siren of a fire engine enters the meeting room. Although the value of the loss function at that timing is larger than the value of the loss function shown in FIG. 14, the magnitude thereof is at most about 40.

Meanwhile, two values each surrounded by a broken line circle in FIG. 16 are values of the loss function when the pencil was dropped in the meeting room. Those values are approximately 1,100 and 1,300, and even though the sound generated when the pencil was dropped was smaller than the sound of the siren, an error value generated in the loss function when the pencil was dropped exceeded the maximum value of the loss function when the sound of the siren reached the meeting room shown in FIG. 15 by an order of magnitude.

That is, it became apparent that, when an appropriate threshold value is set, a sound in the state of Sample 1 in which the loss function of FIG. 15 is generated and a sound in the state of Sample 2 in which the loss function of FIG. 16 is generated can be distinguished from each other by the detection device in the first embodiment. For example, when the threshold value is set to an appropriate value of from about 500 to about 800, Sample 1 and Sample 2 can be clearly distinguished from each other. Needless to say, the state of the meeting room when the sound of Sample 1 was generated is the stationary state, and the state of the meeting room when the sound of Sample 2 was generated is the non-stationary state.

### REFERENCE SIGNS LIST

100 computer device
101 display
102 input device
103 microphone
100X computer device
101X display
102X input device
103X microphone
121 input unit
122 main control unit
123 feature detection unit
124 autoencoder
125 loss function generation unit
126 optimization unit
127 threshold value determination unit
128 output unit
121X input device
122X main control unit
123X feature detection unit
124X first arithmetic unit
125X loss function generation unit
126X state determination unit
127X first recording unit
128X output unit

1. A trained autoencoder, which is obtained by performing pre-training of an autoencoder that encodes input data being predetermined data and then decodes the encoded predetermined data to obtain data having the same dimensions as dimensions of the input data,
wherein the input data is stationary vibration feature data generated from stationary vibration data that is data having a specific duration about stationary vibration including vibration generated in a stationary state from an object for which detection of non-stationarity is performed based on vibration, the stationary vibration feature data being data about a feature of stationary vibration identified by the stationary vibration data, and output data is estimated stationary vibration feature data, and
wherein the pre-training is performed by inputting a plurality of pieces of the stationary vibration feature data so that a difference between the stationary vibration feature data being the input data and the estimated stationary vibration feature data being the output data with respect to the input data is minimized.

2. The trained autoencoder according to claim 1, wherein the stationary vibration feature data is a frequency spectrogram generated from the stationary vibration data.

3. The trained autoencoder according to claim 1, wherein the stationary vibration is a sound generated in the stationary state.

4. The trained autoencoder according to claim 3, wherein the stationary vibration feature data is a mel-frequency spectrogram generated from the stationary vibration data.

5. A method of generating a trained autoencoder from an autoencoder that encodes input data being predetermined data and then decodes the encoded predetermined data to obtain data having the same dimensions as dimensions of the input data,
the input data being stationary vibration feature data generated from stationary vibration data that is data having a specific duration about stationary vibration that is vibration generated in a stationary state from an object for which detection of non-stationarity is performed based on vibration, the stationary vibration feature data being data about a feature of stationary vibration identified by the stationary vibration data, output data being estimated stationary vibration feature data,
the method comprising performing pre-training of the autoencoder by inputting a plurality of pieces of the stationary vibration feature data so that a difference between the stationary vibration feature data being the input data and the estimated stationary vibration feature data being the output data with respect to the input data is minimized.

6. The method according to claim 5, further comprising,
in order to minimize the difference between the stationary vibration feature data and the estimated stationary vibration feature data being the output data with respect to the input data,
generating a loss function for the difference between the stationary vibration feature data and the estimated stationary vibration feature data being the output data with respect to the input data, and
minimizing the generated loss function.

7. A non-stationary vibration detection device, comprising:
a first recording unit having a trained autoencoder recorded therein,
wherein the trained autoencoder is obtained by performing pre-training of an autoencoder that encodes input data being predetermined data and then decodes the encoded predetermined data to obtain data having the same dimensions as dimensions of the input data,
wherein the input data is stationary vibration feature data generated from stationary vibration data that is data having a specific duration about stationary vibration including vibration generated in a stationary state from an object for which detection of non-stationarity is performed based on vibration, the stationary vibration feature data being data about a feature of stationary vibration identified by the stationary vibration data, and output data is estimated stationary vibration feature data, and
wherein the pre-training is performed by inputting a plurality of pieces of the stationary vibration feature data so that a difference between the stationary vibration feature data being the input data and the estimated stationary vibration feature data being the output data with respect to the input data is minimized;
a receiving unit configured to receive measured vibration data that is data having a specific duration about measured vibration including vibration generated from the object for which detection of non-stationarity based on vibration is performed;
a measured vibration feature data generation unit configured to generate, from the measured vibration data received by the receiving unit, measured vibration feature data that is data about a feature of measured vibration identified by the measured vibration data, by the same method as a method of generating the stationary vibration feature data from the stationary vibration data in pre-training;
a first arithmetic unit configured to read the trained autoencoder recorded in the first recording unit and to input the measured vibration feature data generated by the measured vibration feature data generation unit to the trained autoencoder to obtain estimated measured vibration feature data that is an output from the trained autoencoder in response to the input measured vibration feature data; and
a second arithmetic unit configured to obtain a difference between the measured vibration feature data generated by the measured vibration feature data generation unit and the estimated measured vibration feature data generated from the measured vibration feature data by the first arithmetic unit and to determine, when the difference is larger than a predetermined range, that measured vibration identified by measured vibration data from which the measured vibration feature data is derived is non-stationary vibration and generate result data indicating occurrence of non-stationary vibration.

8. The non-stationary vibration detection device according to claim 7, wherein, in order to obtain the difference between the measured vibration feature data generated by the measured vibration feature data generation unit and the estimated measured vibration feature data generated from the measured vibration feature data by the first arithmetic unit, the second arithmetic unit is configured to generate a loss function for the measured vibration feature data and the estimated measured vibration feature data, and determine that measured vibration identified by measured vibration data from which the measured vibration feature data is derived is non-stationary vibration when the number of values of the loss function which exceed a predetermined threshold value is a predetermined number or more.

9. The non-stationary vibration detection device according to claim 7, wherein the measured vibration feature data is a frequency spectrogram generated from the measured vibration data.

10. The non-stationary vibration detection device according to claim 7, wherein the measured vibration is a sound generated during a period in which detection of non-stationarity based on vibration is performed.

11. The non-stationary vibration detection device according to claim 10, wherein the measured vibration feature data is a mel-frequency spectrogram generated from the measured vibration data.

12. A non-stationary vibration detection method, which is executed by a computer including a first recording unit having a trained autoencoder recorded therein,
wherein the trained autoencoder is obtained by performing pre-training of an autoencoder that encodes input data being predetermined data and then decodes the encoded predetermined data to obtain data having the same dimensions as dimensions of the input data,
wherein the input data is stationary vibration feature data generated from stationary vibration data that is data having a specific duration about stationary vibration including vibration generated in a stationary state from an object for which detection of non-stationarity is performed based on vibration, the stationary vibration feature data being data about a feature of stationary vibration identified by the stationary vibration data, and output data is estimated stationary vibration feature data, and
wherein the pre-training is performed by inputting a plurality of pieces of the stationary vibration feature data so that a difference between the stationary vibration feature data being the input data and the estimated stationary vibration feature data being the output data with respect to the input data is minimized,
the non-stationary vibration detection method comprising:
a first step of receiving, by the computer, measured vibration data that is data having a specific duration about measured vibration including vibration generated from the object for which detection of non-stationarity based on vibration is performed;
a second step of generating, by the computer, from the measured vibration data received in the first step, measured vibration feature data that is data about a feature of measured vibration identified by the measured vibration data, by the same method as a method of generating the stationary vibration feature data from the stationary vibration data in pre-training;
a third step of reading, by the computer, the trained autoencoder recorded in the first recording unit and inputting the measured vibration feature data generated in the second step to the trained autoencoder to obtain estimated measured vibration feature data that is an output from the trained autoencoder in response to the measured vibration feature data; and
a fourth step of obtaining, by the computer, a difference between the measured vibration feature data generated in the second step and the estimated measured vibration feature data generated from the measured vibration feature data in the third step and determining, when the difference is larger than a predetermined range, that measured vibration identified by measured vibration data from which the measured vibration feature data is derived is non-stationary vibration and generating result data indicating occurrence of non-stationary vibration.

13. A computer program for causing a predetermined computer to function as a non-stationary vibration detection device, the computer program causing the predetermined computer to function as:
a first recording unit having a trained autoencoder recorded therein, the trained autoencoder being obtained by performing pre-training of an autoencoder that encodes input data being predetermined data and then decodes the encoded predetermined data to obtain data having the same dimensions as dimensions of the input data, the input data being stationary sound vibration feature data generated from stationary sound vibration data that is data having a specific duration about stationary sound vibration including sound vibration generated in a stationary state from an object for which detection of non-stationarity is performed based on sound vibration, the stationary vibration feature data being data about a feature of stationary sound vibration identified by the stationary sound vibration data, output data being estimated stationary sound vibration feature data, the pre-training being performed by inputting a plurality of pieces of the stationary sound vibration feature data so that a difference between the stationary sound vibration feature data being the input data and the estimated stationary sound vibration feature data being the output data with respect to the input data is minimized;
a receiving unit configured to receive measured vibration data that is data having a specific duration about measured vibration including vibration generated from the object for which detection of non-stationarity based on vibration is performed;
a measured vibration feature data generation unit configured to generate, from the measured vibration data received by the receiving unit, measured vibration feature data that is data about a feature of measured vibration identified by the measured vibration data, by the same method as a method of generating the stationary vibration feature data from the stationary vibration data in the pre-training;
a first arithmetic unit configured to read the trained autoencoder recorded in the first recording unit and to input the measured vibration feature data generated by the measured vibration feature data generation unit to the trained autoencoder to obtain estimated measured vibration feature data that is an output of the trained autoencoder in response to the input measured vibration feature data; and
a second arithmetic unit configured to obtain a difference between the measured vibration feature data generated by the measured vibration feature data generation unit and the estimated measured vibration feature data generated from the measured vibration feature data by the first arithmetic unit, and to determine, when the difference is larger than a predetermined range, that measured vibration identified by measured vibration data from which the measured vibration feature data is derived is non-stationary vibration and generate result data indicating occurrence of non-stationary vibration.

14. A method of determining a threshold value to be used in a non-stationary vibration detection device,
the non-stationary vibration detection device comprising:
a first recording unit having a trained autoencoder recorded therein,
wherein the trained autoencoder is obtained by performing pre-training of an autoencoder that encodes input data being predetermined data and then decodes the encoded predetermined data to obtain data having the same dimensions as dimensions of the input data,
wherein the input data is stationary vibration feature data generated from stationary vibration data that is data having a specific duration about stationary vibration including vibration generated in a stationary state from an object for which detection of non-stationarity is performed based on vibration, the stationary vibration feature data being data about a feature of stationary vibration identified by the stationary vibration data, and output data is estimated stationary vibration feature data, and
wherein the pre-training is performed by inputting a plurality of pieces of the stationary vibration feature data so that a difference between the stationary vibration feature data being the input data and the estimated stationary vibration feature data being the output data with respect to the input data is minimized,
a receiving unit configured to receive measured vibration data that is data having a specific duration about measured vibration including vibration generated from the object for which detection of non-stationarity based on vibration is performed,
a measured vibration feature data generation unit configured to generate, from the measured vibration data received by the receiving unit, measured vibration feature data that is data about a feature of measured vibration identified by the measured vibration data, by the same method as a method of generating the stationary vibration feature data from the stationary vibration data in pre-training,
a first arithmetic unit configured to read the trained autoencoder recorded in the first recording unit and to input the measured vibration feature data generated by the measured vibration feature data generation unit to the trained autoencoder to obtain estimated measured vibration feature data that is an output from the trained autoencoder in response to the input measured vibration feature data, and
a second arithmetic unit configured to obtain a difference between the measured vibration feature data generated by the measured vibration feature data generation unit and the estimated measured vibration feature data generated from the measured vibration feature data by the first arithmetic unit and to determine, when the difference is larger than a predetermined range, that measured vibration identified by measured vibration data from which the measured vibration feature data is derived is non-stationary vibration and generate result data indicating occurrence of non-stationary vibration,
wherein, in order to obtain the difference between the measured vibration feature data generated by the measured vibration feature data generation unit and the estimated measured vibration feature data generated from the measured vibration feature data by the first arithmetic unit, the second arithmetic unit is configured to generate a loss function for the measured vibration feature data and the estimated measured vibration feature data, and determine that measured vibration identified by measured vibration data from which the measured vibration feature data is derived is non-stationary vibration when the number of values of the loss function which exceed a predetermined threshold value is a predetermined number or more,
the method comprising:
a step A of inputting, to the trained autoencoder, the stationary vibration feature data generated from the stationary vibration data not used for training of the trained autoencoder, the stationary vibration feature data being data about a feature of stationary vibration identified by the stationary vibration data, to obtain the estimated stationary vibration feature data as an output of the trained autoencoder;
a step B of generating a loss function for a difference between the stationary vibration feature data input to the trained autoencoder in the step A and the estimated stationary vibration feature data generated from the stationary vibration feature data by the trained autoencoder; and
a step C of determining the threshold value based on a mean and a variance of an amplitude related to an error of the loss function obtained in the step B.

15. The non-stationary vibration detection device according to claim 8, wherein the measured vibration feature data is a frequency spectrogram generated from the measured vibration data.
